(19) United States
(12) Patent Application Publication
(10) Pub. No.: US 2026/0339018 A1
(43) Pub. Date: Oct. 29, 2026

(54) PHOTONIC COUPLERS FOR ELECTRONIC/PHOTONIC PACKAGES AND METHODS OF FORMING THE SAME

(71) Applicant: Taiwan Semiconductor Manufacturing Company Limited, Hsinchu (TW)

(72) Inventors: Chen-Hua YU, Hsinchu City (TW); Tung-Liang SHAO, Hsinchu (TW)

(21) Appl. No.: 19/717,729

(22) Filed: Jun. 24, 2026

Related U.S. Application Data
(62) Division of application No. 18/591,150, filed on Feb. 29, 2024.

(51) Int. Cl. G02B 6/12; G02B 6/122; G02B 6/124; G02B 6/13

(52) U.S. Cl. CPC G02B 6/12002; G02B 6/1228; G02B 6/124; G02B 6/13; G02B 2006/12104; G02B 2006/12107

(57) ABSTRACT

An embodiment photonic interconnect die may include a substrate, a dielectric waveguide, including a core portion and a cladding portion, formed on the substrate, a first photonic coupler formed at a first end of the dielectric waveguide, and a second photonic coupler formed at a second end of the dielectric waveguide. The dielectric waveguide may include a planar geometry within the cladding portion such that a surface of the dielectric waveguide is parallel to a first surface of the photonic interconnect die. The first photonic coupler and the second photonic coupler may each be configured to couple photonic signals into and out of the photonic interconnect die such that a photonic signal pathway connects the first photonic coupler, the dielectric waveguide, and the second photonic coupler. The photonic interconnect die may further couple photonic signals into and out of a first dielectric window and a second dielectric window.

### CROSS-REFERENCE TO RELATED APPLICATIONS

This application is a divisional of or relates to U.S. Application No. 18/591,150 entitled “Photonic Couplers For Electronic/Photonic Packages And Methods Of Forming The Same," filed Feb. 29, 2024, which is hereby incorporated by reference in its entirety for all purposes.

### BACKGROUND

Many computing applications use optical (i.e., photonic) signals to provide secure high-speed data transmission. Various emerging technologies are also being developed that may provide functionality to perform computing operations directly on optical/photonic signals. Silicon photonics is a promising technology area that uses semiconductor device processing techniques to provide systems including integrated electronic and photonic components. Such components may be used for the generation, routing, modulation, processing, and detection of light. Together, these functions form a photonic analog to electronic integrated circuits (EIC) and, as such, may constitute photonic integrated circuits (PIC).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic illustration of various components that may be used in a photonic computing system.

FIG. 2 is a schematic top view of an example photonic integrated circuit.

FIG. 3A is vertical cross-sectional view of a photonic integrated circuit formed on a silicon-on-insulator (SOI) substrate, according to various embodiments.

FIG. 3B is vertical cross-sectional view of a portion of the photonic integrated circuit of FIG. 3A showing photonic components, according to various embodiments.

FIG. 3C is vertical cross-sectional view of a further portion of the photonic integrated circuit of FIG. 3A showing a photonic coupler, according to various embodiments.

FIG. 3D is vertical cross-sectional view of a further portion of the photonic integrated circuit of FIG. 3A showing a further photonic coupler, according to various embodiments.

FIG. 4 is a vertical cross-sectional view of an electronic/photonic package including an optical engine and a separate electronic component, according to various embodiments.

FIG. 5A is a top view of a further electronic/photonic package including a photonic interconnect die, according to various embodiments.

FIG. 5B is a vertical cross-sectional view of the electronic/photonic package of FIG. 5A, according to various embodiments.

FIG. 6A is a top view of a photonic interconnect die that photonically connects a first photonic component and a second photonic component, according to various embodiments.

FIG. 6B is a top view of a photonic interconnect die that photonically connects a first photonic component, a second photonic component, a third photonic component, and a fourth photonic component, according to various embodiments.

FIG. 7 is a vertical cross-sectional view of a further electronic/photonic package including a photonic interconnect die, according to various embodiments.

FIG. 8A is a top view of a further electronic/photonic package including a first photonic interconnect die, a second photonic interconnect die, and a third photonic interconnect die, according to various embodiments.

FIG. 8B is a vertical cross-sectional view of the electronic/photonic package of FIG. 8A, according to various embodiments.

FIG. 8C is a three-dimensional perspective view showing details of a fiber array unit, according to various embodiments.

FIG. 9A is a top view of a further electronic/photonic package including a plurality of photonic interconnect dies, according to various embodiments.

FIG. 9B is a vertical cross-sectional view of a portion of the electronic/photonic package of FIG. 9A, according to various embodiments.

FIG. 10A is a top view of a further electronic/photonic package including a plurality of photonic interconnect dies, according to various embodiments.

FIG. 10B is a vertical cross-sectional view of a portion of the electronic/photonic package of FIG. 10A, according to various embodiments.

FIG. 11 is a top view of a further electronic/photonic package including a first component package and a second component package, according to various embodiments.

FIG. 12 is a vertical cross-sectional view of a further electronic/photonic package including a photonic interconnect die having edge couplers, according to various embodiments.

FIG. 13 is a vertical cross-sectional view of a further electronic/photonic package including a photonic interconnect die that couples photonic signals between two hybrid interposers, according to various embodiments.

FIG. 14A is a vertical cross-sectional view of an intermediate structure that may be used to form a photonic interconnect die, according to various embodiments.

FIG. 14B is a vertical cross-sectional view of a further intermediate structure that may be used to form a photonic interconnect die, according to various embodiments.

FIG. 14C is a vertical cross-sectional view of a further intermediate structure that may be used to form a photonic interconnect die, according to various embodiments.

FIG. 14D is a vertical cross-sectional view of a further intermediate structure that may be used to form a photonic interconnect die, according to various embodiments.

FIG. 14E is a top view of a further intermediate structure that may be used to form a photonic interconnect die, according to various embodiments.

FIG. 15A is a vertical cross-sectional view of a further intermediate structure that may be used to form a photonic interconnect die, according to various embodiments.

FIG. 15B is a vertical cross-sectional view of a further intermediate structure that may be used to form a photonic interconnect die, according to various embodiments.

FIG. 15C is a vertical cross-sectional view of a further intermediate structure that may be used to form a photonic interconnect die, according to various embodiments.

FIG. 16A is a vertical cross-sectional view of a further intermediate structure that may be used to form a photonic interconnect die, according to various embodiments.

FIG. 16B is a vertical cross-sectional view of a further intermediate structure that may be used to form a photonic interconnect die, according to various embodiments.

FIG. 16C is a vertical cross-sectional view of a further intermediate structure that may be used to form a photonic interconnect die, according to various embodiments.

FIG. 16D is a vertical cross-sectional view of a photonic interconnect die, according to various embodiments.

FIG. 16E is a vertical cross-sectional view of a further photonic interconnect die, according to various embodiments.

FIG. 16F is a vertical cross-sectional view of a further photonic interconnect die, according to various embodiments.

FIG. 16G is a vertical cross-sectional view of a further photonic interconnect die, according to various embodiments.

FIG. 16H is a vertical cross-sectional view of a further photonic interconnect die, according to various embodiments.

FIG. 17A is a top view of a photonic interconnect die including edge couplers, according to various embodiments.

FIG. 17B is a vertical cross-sectional view of the photonic interconnect die of FIG. 17A, according to various embodiments.

FIG. 18A is a top view of an intermediate structure that may be used to form a photonic interconnect die including grating couplers, according to various embodiments.

FIG. 18B is a vertical cross-sectional view of the intermediate structure of FIG. 18A, according to various embodiments.

FIG. 18C is a vertical cross-sectional view of a photonic interconnect die including grating couplers, according to various embodiments.

FIG. 19A is a top view of an intermediate structure that may be used to form a photonic interconnect die, according to various embodiments.

FIG. 19B is a top view of a further intermediate structure that may be used to form a photonic interconnect die, according to various embodiments.

FIG. 19C is a top view of a further intermediate structure that may be used to form a photonic interconnect die, according to various embodiments.

FIG. 19D is a top view of a further intermediate structure that may be used to form a photonic interconnect die, according to various embodiments.

FIG. 20 is a flowchart illustration operations of a method of forming a photonic interconnect die, according to various embodiments.

### DETAILED DESCRIPTION

The following disclosure provides many different embodiments, or examples, for implementing unique features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Unless explicitly stated otherwise, each element having the same reference numeral is presumed to have the same material composition and to have a thickness within a same thickness range.

Various embodiments disclosed herein provide photonic interconnect dies that allow photonic signals to be propagated between a first photonic component and a second photonic component in an electronic/photonic package. The incorporation of optical/photonic signaling functionality into an electronic/photonic package may provide reduced signal delay and ohmic loss. In this regard, in certain embodiments, to avoid long electrical signal pathways and associated delay and ohmic loss, it may be advantageous to convey signals in the form of photonic signals along a portion of the signal pathway. This may be done by converting electrical signals into photonic signals at a first point along the signal pathway, propagating the photonic signals for a certain distance, and then converting the photonic signals back into electrical signals at a second point along the signal pathway. In still further embodiments, the functionality to convert electrical signals into photonic signals and vice versa may be advantageous in photonic (quantum or classical) computing operations. The use of photonic interconnect dies allows various electronic and photonic components to be fabricated separately as stand-alone dies. Such dies may then be assembled into an electronic/photonic package and photonic components may be coupled by photonic interconnect dies.

An embodiment photonic interconnect die may include a substrate, a dielectric waveguide, including a core portion and a cladding portion, formed on the substrate, a first photonic coupler formed at a first end of the dielectric waveguide, and a second photonic coupler formed at a second end of the dielectric waveguide. The dielectric waveguide may include a planar geometry within the cladding portion such that a surface of the dielectric waveguide is parallel to a first surface of the photonic interconnect die. The first photonic coupler and the second photonic coupler may each be configured to couple photonic signals into and out of the photonic interconnect die such that a photonic signal pathway connects the first photonic coupler, the dielectric waveguide, and the second photonic coupler. The photonic interconnect die may further couple photonic signals into and out of a first dielectric window and a second dielectric window.

According to a further embodiment, an electronic/photonic package is provided. The electronic/photonic package may include a first photonic component including first photonic signal pathways, a second photonic component including second photonic signal pathways, and a photonic interconnect die including a plurality of dielectric waveguides. The photonic interconnect die may be coupled to the first photonic component and the second photonic component such that the first photonic signal pathways are photonically coupled to the second photonic signal pathways by the plurality of dielectric waveguides.

An embodiment method of forming a photonic interconnect die may include forming a waveguide cladding portion on a substrate; forming a waveguide core portion within the waveguide cladding portion; forming a first photonic coupler at a first end of the waveguide core portion; and forming a second photonic coupler at a second end of the waveguide core portion.

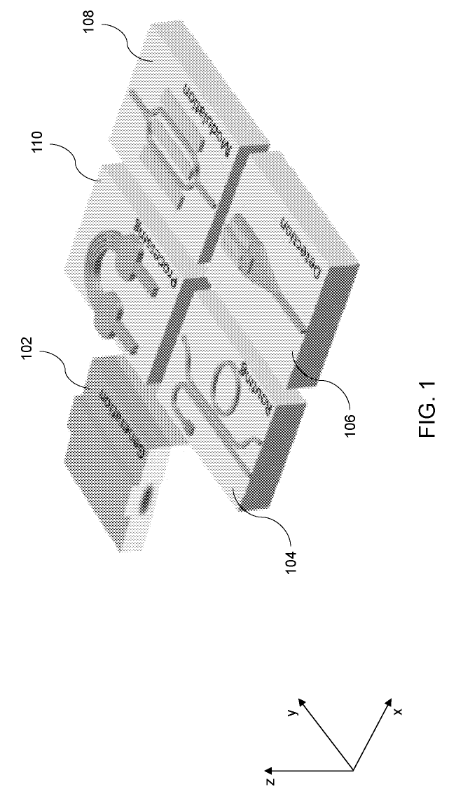

FIG. 1 is an illustration of various components that may be used in a photonic computing system. System components may include a generation device also referred to as a photonic source 102 such as a laser or light-emitting diode (LED), a routing device that may include a plurality of dielectric waveguides 104 configured to route photonic signals, and a detector that includes one or more photonic detectors 106 configured to detect photonic signals and to convert received photonic signals into output electrical signals. Additional components may include a modulation device that includes one or more photonic modulators 108 and photonic processing components 110.

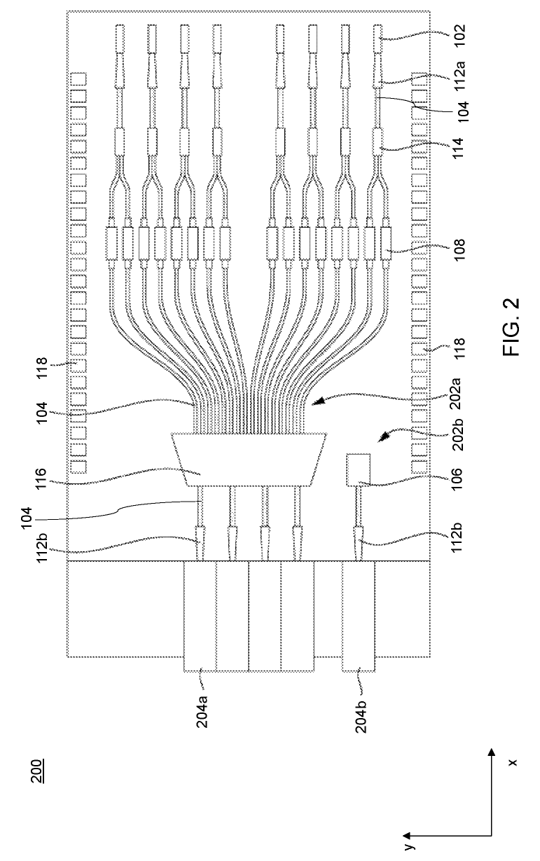

The one or more photonic modulators 108 may take an input electronic signal and may modulate an input photonic signal to impose an amplitude and/or phase modulation on the input photonic signal in response to an input electronic signal. In this way, the one or more photonic modulators 108 may be used to convert data provided in the form of an electronic signal into data encoded as a photonic signal. Similarly, the one or more photonic detectors 106 may convert processed photonic signals back into output electrical signals. The photonic processing components 110 may be configured to perform (classical or quantum) logic operations on the modulated photonic signal. The various photonic components (102 to 110) may be integrated within a single die to thereby form a photonic integrated circuit (PIC), as described in greater detail with reference to FIGS. 2 -3D, below.

FIG. 2 is a schematic top view of an example PIC 200, according to various embodiments. The PIC 200 may include photonic sources 102, first photonic couplers 112a, dielectric waveguides 104, beam splitters 114, photonic modulators 108, a photonic multiplexer 116, second photonic couplers 112b, and one or more photonic detectors 106. Other components (not shown) may include active or passive photonic amplifiers, photonic switches, (quantum or classical) logic gates, etc. The PIC 200 of FIG. 2 may be configured as a photonic transceiver that may generate a plurality of photonic signals along a transmitter path 202a and may receive phonic signals along a receiver path 202b. In other embodiments (not shown) the PIC may be configured as a transmitter (i.e., omitting the receiver path 202b) or as a receiver (i.e., omitting the transmitting path 202a). Various other PIC devices (not shown) may provide various other types of functionality such as allowing logic operations to be performed directly on photonic signals.

In the example embodiment PIC 200 of FIG. 2, the transmitter path 202a may be configured to receive input electrical signals from various input electrical connections (e.g., certain ones of a plurality of electrical circuit pads 118) and may generate output photonic signals that may be provided to one or more output channels, such as output optical fibers 204a. The receiver path 202b may receive various input photonic signals from one or more input channels, such as input optical fibers 204b and may convert the received input photonic signals to corresponding output electrical signals that may be provided to various output electrical connections (e.g., other ones of the plurality of electrical circuit pads 118).

According to various embodiments, the transmitter path 202a may be configured as follows. Each photonic source 102 may include a laser or LED that may generate an unmodulated signal, such as a continuous wave (CW) light/radiation beam. The unmodulated signal generated by each photonic source 102 may then be provided to a respective first photonic coupler 112a, which may then provide the unmodulated signal to a dielectric waveguide 104 and to a photonic modulator 108. As shown, beam splitters 114 may also be used to increase a number of signals provided to the photonic modulators 108. Each photonic modulator 108 may then generate a modulated signal from a respective received unmodulated signal in response to a time-dependent input electrical signal (e.g., received from some of the electrical circuit pads 118). The modulated signals may then be fed to the multiplexer 116 by additional dielectric waveguides 104. The multiplexer 116 may then generate multiplexed output signal that may be fed to respective output channels, such as the output optical fibers 204a.

The various photonic sources 102 may generate a plurality of unmodulated signals having a corresponding plurality of respective wavelengths. The multiplexer 116 may then combine various modulated signals having different wavelengths into a smaller number of output photonic channels that may carry the multiplexed signals. Other photonic system components (e.g., photonic processing components 110) may then receive the multiplexed photonic signals and may use a de-multiplexer (not shown) to separate (i.e., de-multiplex) the various photonic signals for further processing operations.

As shown in FIG. 2, the receiver path 202b may include one or more photonic detectors 106. For simplicity of description, only a single photonic detector 106 is shown. According to various embodiments, however, the PIC 200 may include a plurality of input optical fibers 204b that may receive a plurality of corresponding input photonic signals. In some embodiments, the input optical signals may include multiplexed data including photonic signals having a plurality of wavelengths. A de-multiplexer (not shown) may then separate the various signals having respective wavelengths. Each separated signal may then be provided to a respective photonic detector 106, which may convert the received photonic signal into a corresponding output electrical signal. The resulting output electrical signal may then be provided as output to other ones of the electrical circuit pads 118.

Some of the components of the PIC 200 may be passive components (e.g., beam splitters 114, dielectric waveguides 104, multiplexer 116, etc.) that do not generate or receive electrical signals. Other components of the PIC 200 may be active components (e.g., photonic sources 102, photonic detectors 106, modulators 108, etc.) that may receive or generate electrical signals. As such, the PIC 200 may include both electrical and photonic circuits. As described above, the PIC 200 may include a plurality of electrical circuit pads 118 that may be electrically connected to the various active components of the PIC 200. As such, some of the plurality of electrical circuit pads 118 may be configured to receive input electrical signals and other ones of the plurality of electrical circuit pads 118 may be configured to provide output electrical signals. Still further other ones of the plurality of electrical circuit pads 118 may be configured to receive electrical power that may be provided to the active components that require a power supply (e.g., the photonic sources 102).

According to various embodiments, the electrical and photonic circuit elements of the PIC 200 may be formed using semiconductor processing techniques in various front-end-of-line (FEOL) and back-end-of-line (BEOL) operations. As such, the PIC 200 may be fabricated as a stand-alone photonic die that may be incorporated into a photonic package structure, as described in greater detail below. In this regard, various electro-optic circuit elements (e.g., the photonic sources 102 and photonic detectors 106) may include semiconductor device components that may be fabricated at a semiconductor substrate level in a FEOL process as well as at various interconnect levels in a BEOL process. For example, in some embodiments, certain active components may include control circuits including transistor structures (e.g., CMOS circuits) formed in a FEOL process.

Various electrical interconnect structures and other transistor structures may be formed in a BEOL process. Active and passive components may be formed within or above various interconnect levels in BEOL processes. For example, electro-optical components (e.g., photonic sources 102, photonic modulators 108, photonic detectors 106, etc.) may be formed in BEOL processes and may include, for example, thin-film transistors that may include, for example, oxide semiconductor materials. Passive components, such as dielectric waveguides 104, may be formed by deposition and patterning of various dielectric structures. For example, a dielectric waveguide 104 may be formed to include a core material having a higher index of refraction than a surrounding cladding material, as described in greater detail below.

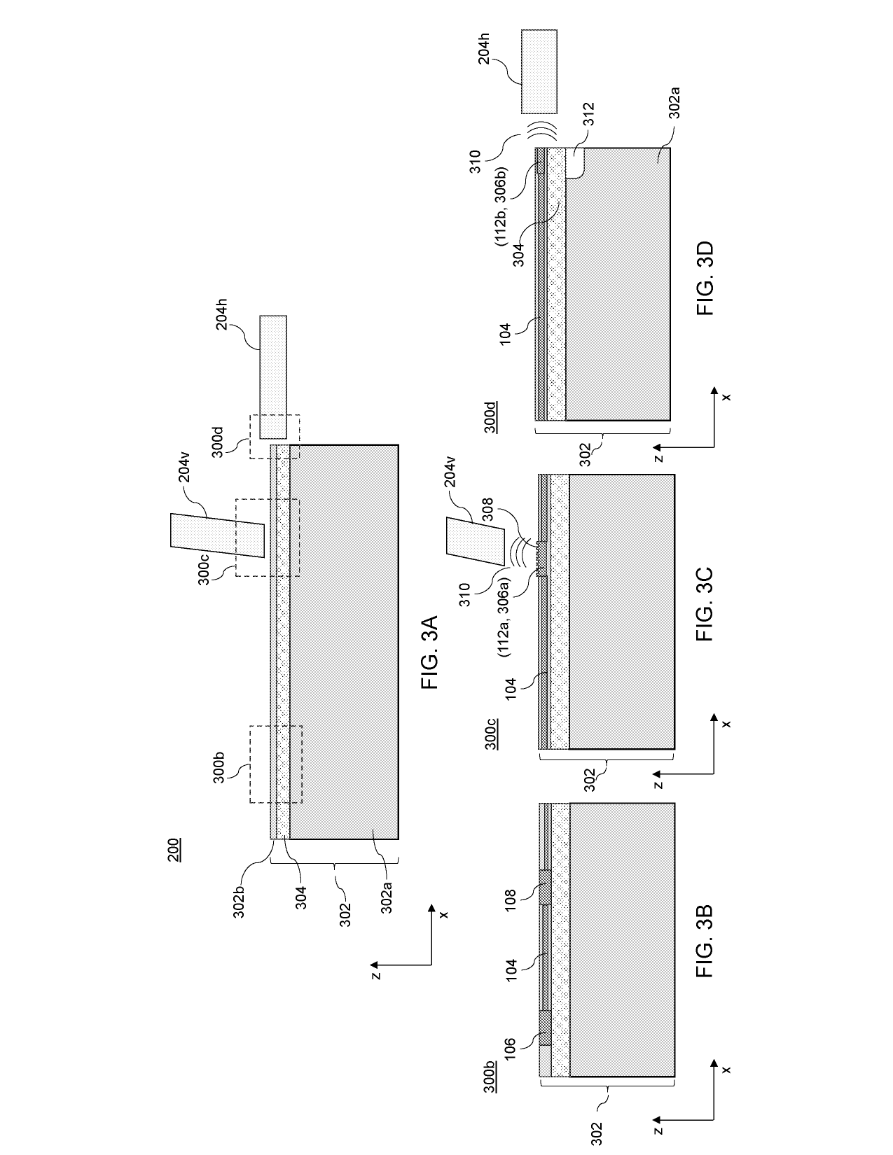

FIG. 3A is vertical cross-sectional view of a PIC 200 formed on a silicon-on-insulator (SOI) substrate 302, according to various embodiments. The SOI substrate 302 may include a silicon substrate layer 302a, an oxide layer 304 formed over the silicon substrate layer 302a, and a silicon layer 302b formed over the oxide layer 304. As described above, semiconductor device fabrication techniques (e.g., lithographic patterning and etching) may be performed on the silicon layer 302b to thereby form photonic components (104, 106, 108) and photonic couplers (112a, 112b).

As shown in FIG. 3A, a vertically oriented optical fiber 204v may be coupled to the PIC 200 in a nominally vertical orientation, as described in greater detail with reference to FIG. 3C, below. Alternatively, a horizontally oriented optical fiber 204h may be coupled to the PIC 200, as described in further detail with reference to FIG. 3D, below. The PIC 200 may also include various electrical circuit elements (not shown) that may also be formed along with the photonic components (104, 106, 108) and photonic couplers (112a, 112b) using semiconductor device fabrication techniques. As described above with reference to FIG. 2, the electrical circuit elements may provide electrical power to active photonic components and may allow input electrical signals to be provided to the PIC 200 and for output electrical signals to be received from the PIC 200 by other components.

FIG. 3B is vertical cross-sectional view of a portion 300b of the PIC 200 of FIG. 3A showing photonic components (104, 106, 108), according to various embodiments. FIG. 3C is vertical cross-sectional view of a further portion 300c of the PIC 200 of FIG. 3A showing a first photonic coupler 112a, according to various embodiments, and FIG. 3D is vertical cross-sectional view of a further portion 300d of the photonic integrated circuit of FIG. 3A showing a second photonic coupler 112b, according to various embodiments. As shown in FIG. 3B, the photonic components (104, 106, 108) may include dielectric waveguides 104, photonic detectors 106, photonic modulators 108, etc. Other photonic components (not shown) may include photonic sources 102, splitters 114, multiplexers 116, etc.

Photonic signals may be coupled into and out from the PIC 200 by various photonic couplers (112a, 112b). As shown in FIG. 3C, the first photonic coupler 112a may be a grating coupler 306athat may allow coupling between the PIC 200 and a vertically oriented optical fiber 204v. Further, as shown in FIG. 3D, the second photonic coupler 112b may be configured as an edge coupler 306b that may allow coupling between the PIC 200 and a horizontally oriented optical fiber 204h. The first photonic coupler 112a may be formed by etching a periodic array of shallow grooves 308 in the dielectric waveguide 104. Every such shallow groove in the periodic array may act as a scatterer of electro-magnetic radiation (i.e., light/photons). As such, the first photonic coupler 112a may be configured as a diffraction grating. Such a diffraction grating may be configured such that scattered contributions from the various grooves interfere constructively in predetermined direction (e.g., 8-10 degrees relative to an upward of a top surface of the PIC 200). In this way, a photonic signal 310 (i.e., an electromagnetic wave) may be coupled from the first photonic coupler 112ato the vertically oriented optical fiber 204v as shown in FIG. 3C. Similarly photonic signals (not shown) may be coupled from the vertically oriented optical fiber 204v into the PIC 200 by way of the first photonic coupler 112a.

As shown in FIG. 3D, the second photonic coupler 112b may be configured as an edge coupler 306b. In this regard, a photonic signal 310 (i.e., light/photons) may be coupled out of a surface of a dielectric waveguide 104 (also referred to as “butt-coupling”) and into the horizontally oriented optical fiber 204h. According to various embodiments, however, there may be a disparity in optical mode size between the dielectric waveguide 104 and the horizontally oriented optical fiber 204h. In this regard, the optical mode size refers to a spatial extent of electro-magnetic fields in directions perpendicular (e.g., along the z-axis) to a longitudinal axis (e.g., along the x-axis) of the dielectric waveguide 104. For example, a silicon dielectric waveguide 104 may have an optical mode size that is between 3-4 microns, while a mode size of an optical fiber may be between 8-10 microns.

To accommodate for the disparity in mode sizes between the dielectric waveguide 104 and the horizontally oriented optical fiber 204h, the second photonic coupler 112b may include a spot-size-converter (SSC). The SSC (not shown) may have a lateral profile that gradually changes size with distance along the propagation direction (e.g., along the x-axis in FIG. 3D). By slowly changing (e.g., increasing) the lateral size of the SSC, light propagating within the SSC may be confined in the fundamental optical mode with a spot size being gradually expanded to match a size of a fiber core (not shown) of the horizontally oriented optical fiber 204h. To reduce optical insertion loss, an undercut structure 312 may be provided to prevent the expanded optical mode propagating within the SSC from overlapping with the silicon substrate layer 302a underneath the SSC.

As shown in FIG. 3D, the undercut structure 312 may be a region free of silicon under the second photonic coupler 112b and may be formed by performing a two-step etching process. In a first operation, openings (not shown) may be etched in the SOI substrate 302. The openings may then provide a conduit for etchant chemicals, in a wet etching process, to reach a silicon surface at an interface between the silicon substrate layer 302a and the oxide layer 304 in a second etching process. In this regard, the silicon may be isotropically etched through the openings. A dielectric material may then be formed in the undercut structure 312 to provide structural stability to the undercut structure 312. The dielectric material may be chosen to have a refractive index sufficiently different from that of silicon such that the optical mode does not propagate within the undercut region 312.

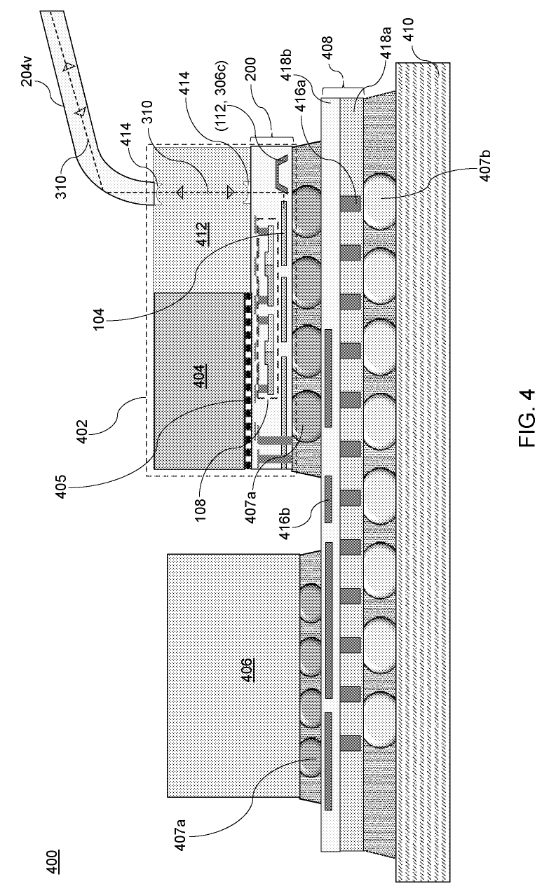

FIG. 4 is a vertical cross-sectional view of an electronic/photonic package 400 including an optical engine 402 and an electronic component 406, according to various embodiments. The optical engine 402 may be configured to convert electrical signals into photonic signals 310 and vice versa. The electronic component 406 may be an active EIC such as a CPU die, a GPU die, an application specific integrated circuit (ASIC), a memory die, etc. Alternatively, the electronic component 406 may be a passive component such as a capacitor, an inductor, as resistor, a diode, a transformer, an integrated passive die, etc.

The optical engine 402 and the electronic component 406 may each be attached to, and electrically coupled to, an electronic interposer 408. Each of the optical engine 402 and the electronic component 406 may further receive electrical signals from, and may transmit electrical signals to, the electronic interposer 408. In this regard, the optical engine 402 and the electronic component 406 may communicate with one another by way of electrical connections provided by the electronic interposer 408. The optical engine 402 and the electronic component 406 may be attached to the electronic interposer 408 with a plurality of first solder material portions 407a. The electronic interposer 408 may, in turn, be attached to, and electrically coupled to, a package substrate 410 with a plurality of second solder material portions 407b. The package substrate 410 may allow the electronic/photonic package 400 to be connected to other system components such as a printed circuit board (PCB) (not shown).

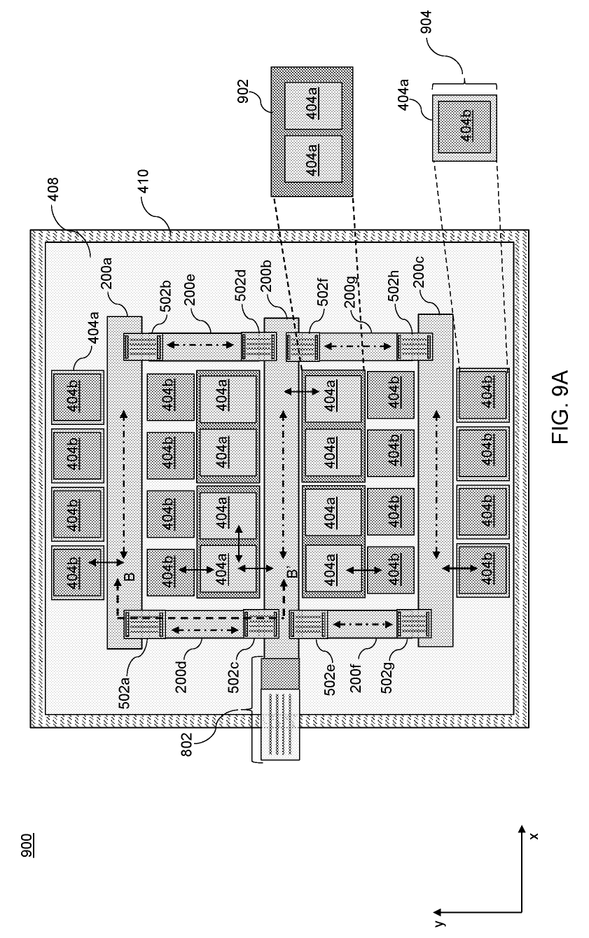

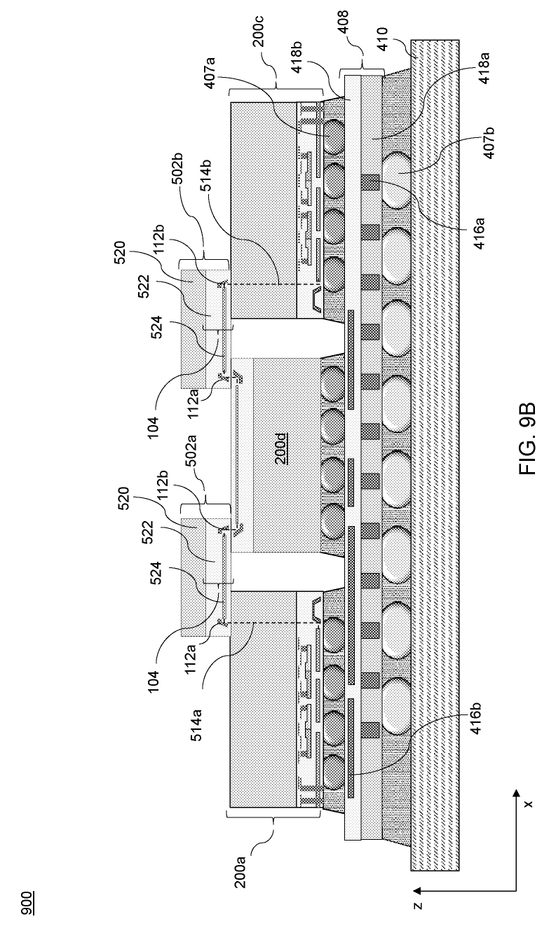

The optical engine 402 may be used to reduce signal delay and ohmic loss by providing an optical/photonic signaling functionality. Thus, in certain embodiments, to avoid long electrical signal pathways and associated delay and ohmic loss, it may be advantageous to convey signals in the form of photonic signals along a portion of the signal pathway. This may be done by converting electrical signals into photonic signals at a first point along the signal pathway, propagating the photonic signals for a certain distance, and then converting the photonic signals back into electrical signals at a second point along the signal pathway. In still further embodiments, the functionality to convert electrical signals into photonic signals and vice versa may be advantageous in photonic (quantum or classical) computing operations, as described in greater detail with reference to FIGS. 9A and 9B, below.

The optical engine 402 may be configured as a co-packaged electronic/photonic die. In this regard, an EIC 404 may be bonded to a PIC 200 with hybrid bonding structures 405. As described above with reference to FIGS. 2 -3D, the PIC 200 may include electrical and optical/photonic circuits that may be configured to generate photonic signals 310 based on received electrical signals. The optical engine 402 may also receive photonic signals 310 and may process the received photonic signals 310 to generate electrical signals that may be provided to the electronic interposer 408 as output.

The EIC 404 may be configured to provide control signals to the PIC 200. For example, the EIC 404 may provide a modulated electrical signal that may encode digital information. The PIC 200 may then use various electro-optic components to generate photonic signals 310 based on the modulated electrical signal received from the EIC 404. For example, the PIC 200 may include one or more photonic modulators 108 and one or more dielectric waveguides 104. The PIC 200 may further include one or more optical couplers 112 that may convey photonic signals 310 between the PIC 200 and an integrated optics section 412 of the optical engine 402. The integrated optics section 412 may include various optical components such as lenses 414, reflectors (not shown), diffraction gratings (also not shown), etc. The integrated optics section 412 may further include various coupling structures (e.g., a fiber array unit (not shown)) that may optically couple the integrated optics section 412 to one or more optical fibers. For example, as shown in FIG. 4, the integrated optics section 412 may be mechanically and optically coupled to a nominally vertically oriented optical fiber 204v.

As shown in FIG. 4, the electronic interposer 408 may include a plurality of electrical interconnects (416a, 416b) formed within one or more dielectric layers (418a, 418b). In various embodiments, the electronic interposer 408 may be a semiconductor interposer, a glass interposer, or an organic interposer. In this regard, the first dielectric layer 418a may be a glass layer, a semiconductor layer (e.g., a silicon layer), or a layer of a polymer material, and the second dielectric layer 418b may be another polymer material. For example, the first dielectric layer 418a may be silicon substrate and the second dielectric layer may be a polymer material such as polyimide (PI), benzocyclobutene (BCB), or polybenzo-bisoxazole (PBO). In such an embodiment, the first electrical interconnects 416a may be formed within the first dielectric layer 418a by performing semiconductor device processing operations. For example, processing operations may include patterning and etching the first dielectric layer 418a followed by deposition of an electrically conducting material (e.g., Al, Cu, etc.) to form the first electrical interconnects 416a.

According to some embodiments, the second electrical interconnects 416b may be formed within the second dielectric layer 418b as redistribution interconnects. In this regard, the second dielectric material 418b may be formed as sequentially deposited layers of a polymer material such as PI, BCB, PBO, etc. Each of the sequentially deposited layers may then be patterned and an electrically conducting material (e.g., Ti, Cu, Ni, Al) may be sequentially deposited (e.g., by electroplating) to form the second electrical interconnects 416b within the second dielectric layer 418b. In some embodiments, the second electrical interconnects 416b may have a fan-out configuration (not shown).

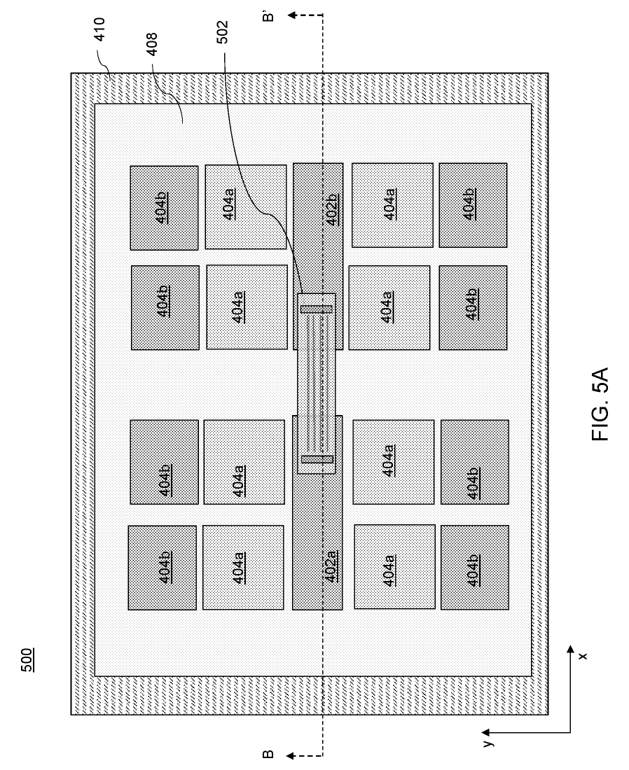

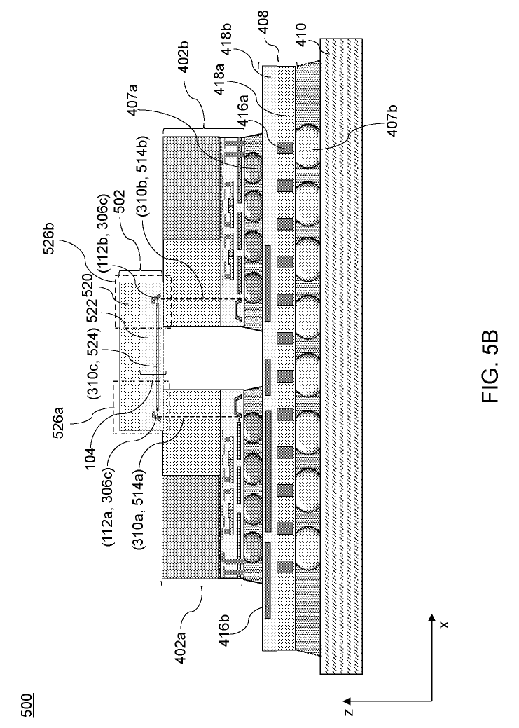

FIG. 5A is a top view of a further electronic/photonic package 500 including a photonic interconnect die 502, and FIG. 5B is a vertical cross-sectional view of the electronic/photonic package 500 of FIG. 5A, according to various embodiments. The vertical plane defining the cross-sectional view of FIG. 5B is indicated by the cross-section B – B’ in FIG. 5A. The electronic/photonic package 500 may include a plurality of first EICs 404a and a plurality of second EICs 404b. Each of the plurality of first EICs 404a may provide a first functionality and each of the plurality of second EICs 404b may provide a second functionality. For example, the plurality of first EICs 404a may be CPU dies, GPU dies, application specific integrated circuits (ASICs), etc., which may provide a functionality to perform computational logic operations. In various embodiments, the plurality of second EICs 404b may be memory (e.g., high-bandwidth memory (HBM)) dies that may provide a data storage functionality.

Each of the plurality of first EICs 404a and the plurality of second EICs 404b may be attached to, and electrically coupled to, an electronic interposer 408. The electronic interposer 408 may, in turn, be attached to, and electrically coupled to, a package substrate 410. The electronic interposer 408 may provide electrical connections between the plurality of first EICs 404a and the plurality of second EICs 404b. As such, the electronic interposer 408 may provide power to the various components of the electronic/photonic package 500 and may further provide electrical signal pathways between the components of the electronic/photonic package 500. The package substrate 410 may allow the electronic/photonic package 500 to be connected to other system components such as a printed circuit board (PCB) (not shown).

To reduce signal delay and ohmic loss, the electronic/photonic package 500 may further include photonic components that may provide optical/photonic signaling functionality. For example, the electronic/photonic package 500 may include a first optical engine 402a and a second optical engine 402b. Each of the first optical engine 402a and the second optical engine 402b may be configured to convert electrical signals into photonic signals and vice versa, as described in greater detail with reference to FIG. 4, above.

As shown in FIG. 5B, in addition to the plurality of first EICs 404a and plurality of second EICs 404b, the first optical engine 402a and the second optical engine 402b may also be attached to, and electrically coupled to, the electronic interposer 408. In this regard, the first optical engine 402a and the second optical engine 402b may each be attached to the electronic interposer 408 with a plurality of first solder material portions 407a. The electronic interposer 408 may, in turn, be attached to, and electrically coupled to, the package substrate 410 with a plurality of second solder material portions 407b. As such, each of first optical engine 402a and the second optical engine 402b may receive power from electrical connections provided by the electronic interposer 408.

Each of the first optical engine 402a and the second optical engine 402b may further receive electrical signals from, and may transmit electrical signals to, the electronic interposer 408. In this regard, the first optical engine 402a and the second optical engine 402b may communicate with one another and with other components of the electronic/photonic package 500 by way of electrical connections provided by the electronic interposer 408. For example, one or more of the plurality of first EICs 404a may provide electrical control signals to the first optical engine 402a and the second optical engine 402b.

Certain electrical signals received by the first optical engine 402a may be converted to first photonic signals 310a which may be provided to first photonic signal pathways 514a within the first optical engine 402a. The first photonic signals 310a may propagate within the first photonic signal pathways 514a and may be coupled into second photonic signal pathways 514b within the second optical engine 402b through the photonic interconnect die 502.

In this regard, the photonic interconnect die 502 may include a dielectric waveguide 104 that may be photonically coupled to a first photonic coupler 112a formed at a first end of the dielectric waveguide 104 and a second photonic coupler 112b formed at a second end of the dielectric waveguide 104. The first photonic coupler 112a and the second photonic coupler 112b may each couple photonic signals into and out of the photonic interconnect die 502 such that a photonic signal pathway connects the first photonic coupler 112a, the dielectric waveguide 104, and the second photonic coupler 112b. As shown in FIG. 5B, the photonic interconnect die 502 may include a substrate 520 with a cladding portion 522 formed over the substrate. The dielectric waveguide 104 may further include a core portion 524 formed within the cladding portion 522.

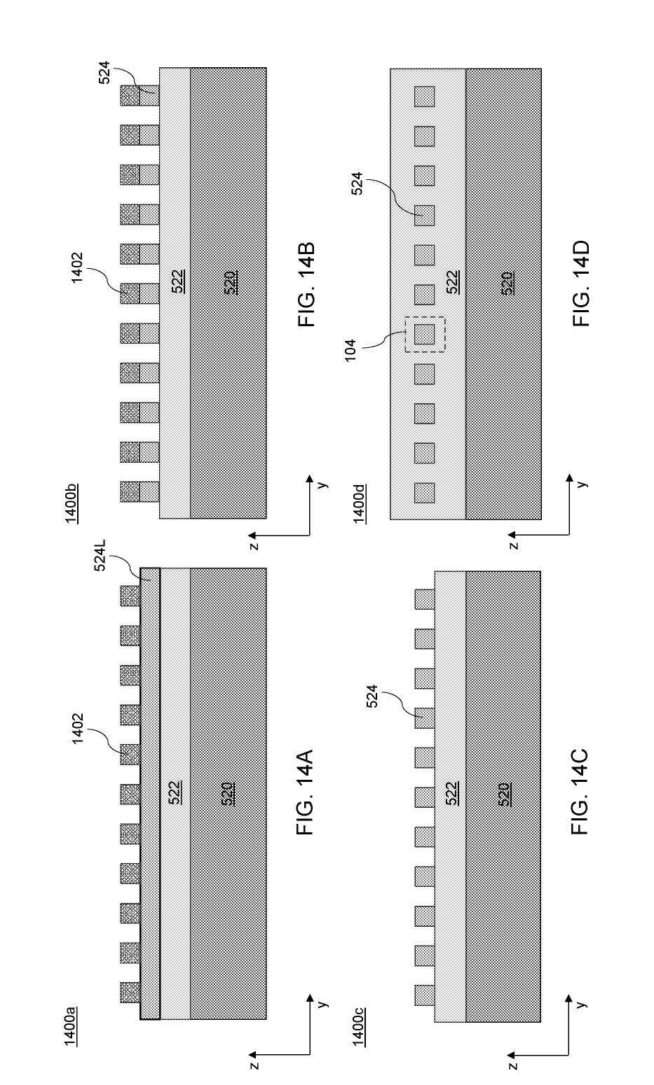

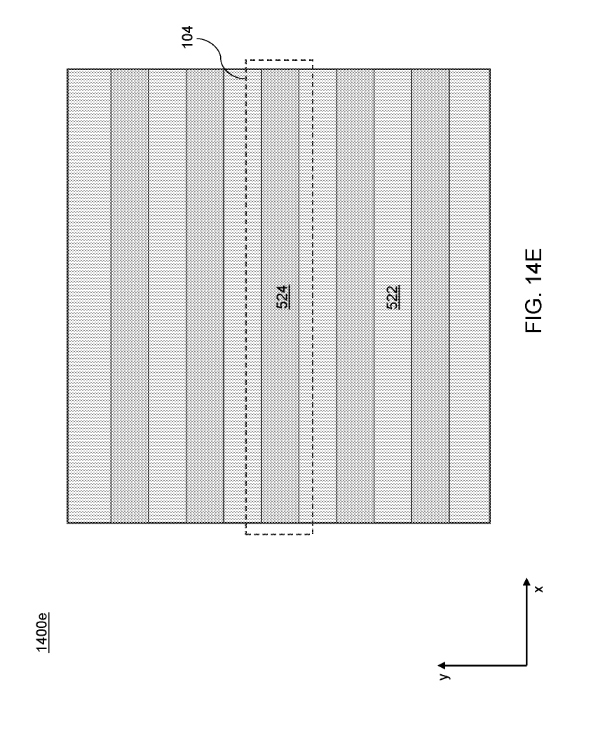

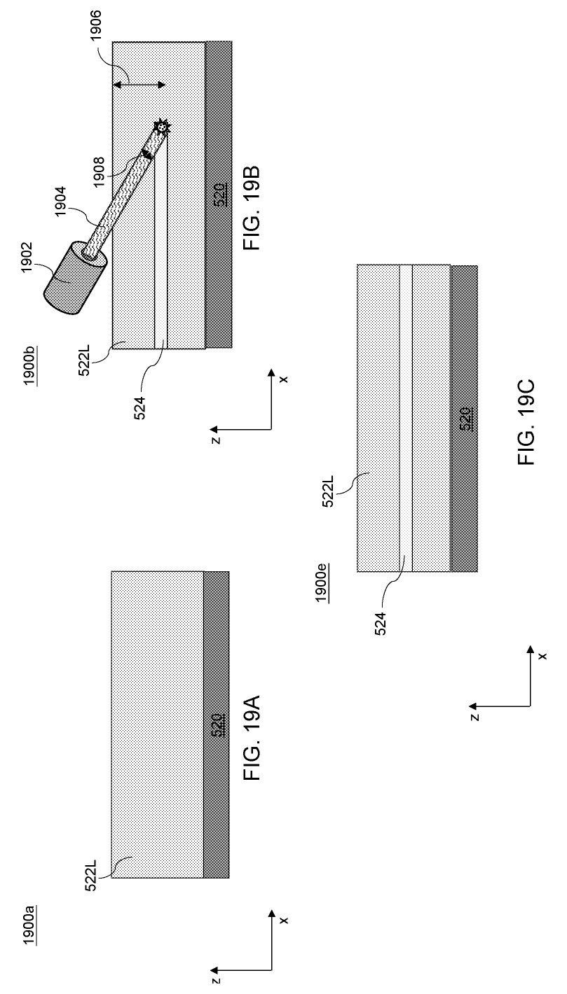

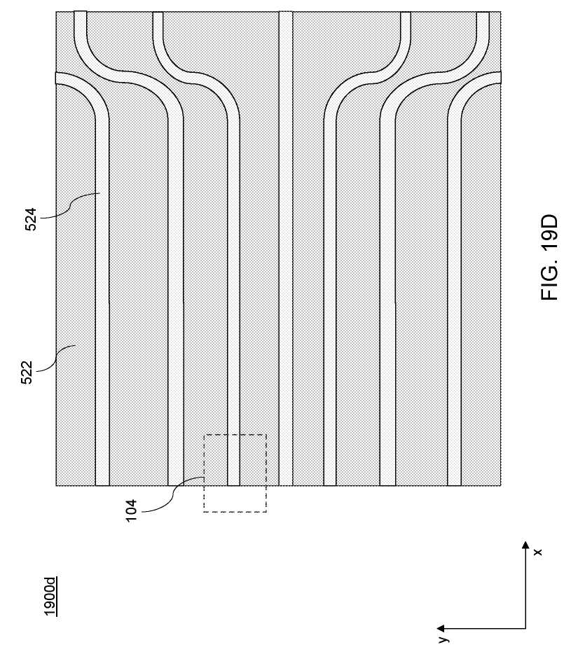

Each of the cladding portion 522 and the core portion 524 may be formed of dielectric materials such that a first index of refraction of the core portion 524 is greater than a second index of refraction of the cladding portion 522. For example, in some embodiments, the substrate 520 may be a semiconductor such as silicon, the cladding portion 522 may be silicon dioxide, and the core portion may be formed of silicon. Such a structure may be formed by patterning a silicon-on-insulator structure, as described with reference to FIGS. 3A - 3D, above. In other embodiments, both the cladding portion 522 and the core portion 524 may be formed of polymer materials, as described in greater detail with reference to FIGS. 14A - 15C, below. In a further example, the core portion 524 may be formed by performing a laser-writing operation on a photosensitive polymer material, as described in greater detail with reference to FIGS. 19A -19D, below. In this regard, a micro-structure of the polymer material may be altered (e.g., a refractive index may be increased) in a localized region in response to absorption of laser radiation during the laser-writing operation. The irradiated localized region may then serve as the core portion 524 while a surrounding un-irradiated portion may serve as the cladding portion 522.

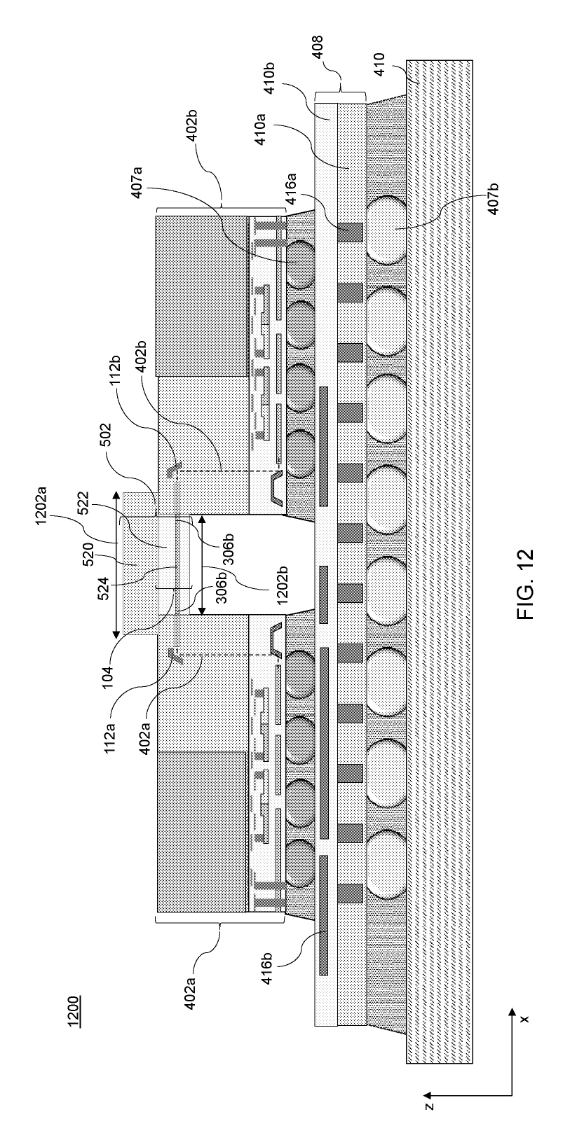

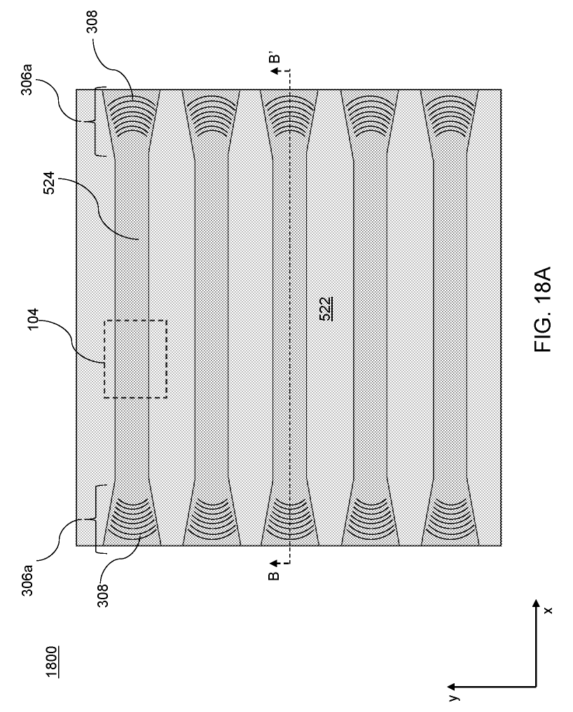

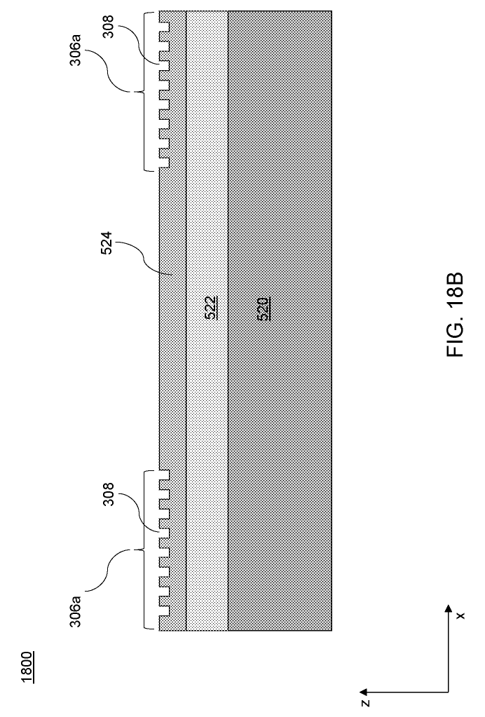

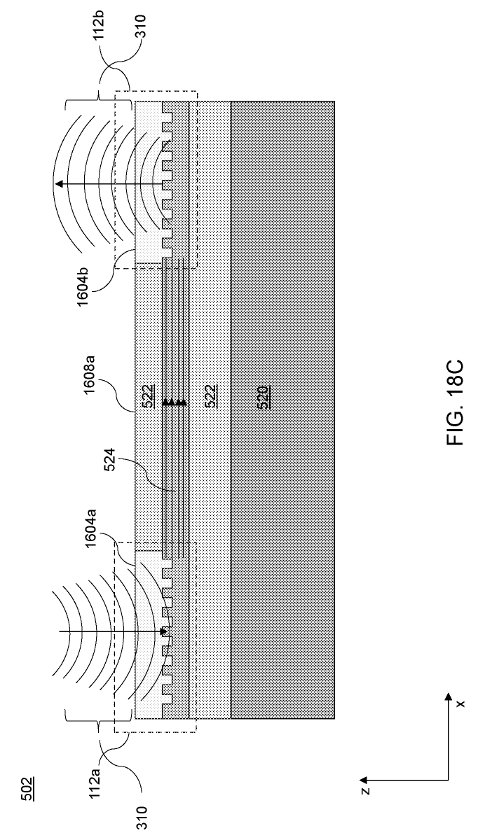

As shown in FIG. 5B, each of the first photonic coupler 112a and the second photonic coupler 112b may be configured as angled reflectors 306c that convert vertically propagating photonic signals into horizontally propagating signals and vice versa. As such, a first photonic signal 310a propagating vertically along the first photonic signal pathway 514a may enter the photonic interconnect die 502 from the first optical engine 402a. Once received by the photonic interconnect die 502 from the first optical engine 402a, the first photonic signal 310a may be converted by the first photonic coupler 112ainto a horizontally propagating photonic signal 310c propagating in the core portion 524 of the dielectric waveguide 104. In turn, the horizontally propagating photonic signal 310c may be received from the dielectric waveguide 104 and may be converted by the second photonic coupler 112b into a second vertically propagating photonic signal 310b that may be provided to the second optical engine 402b. The received second vertically propagating photonic signal 310b may then propagate vertically along the second photonic signal pathways 514b within the second optical engine 402b. Various other types of photonic couplers may be provided in other embodiments. For example, grating couplers 306a (e.g., see FIGS. 3C and 18C) and edge couplers 306b (e.g., see FIGS. 3D and 12) and may be provided in other embodiments as described in greater detail, below.

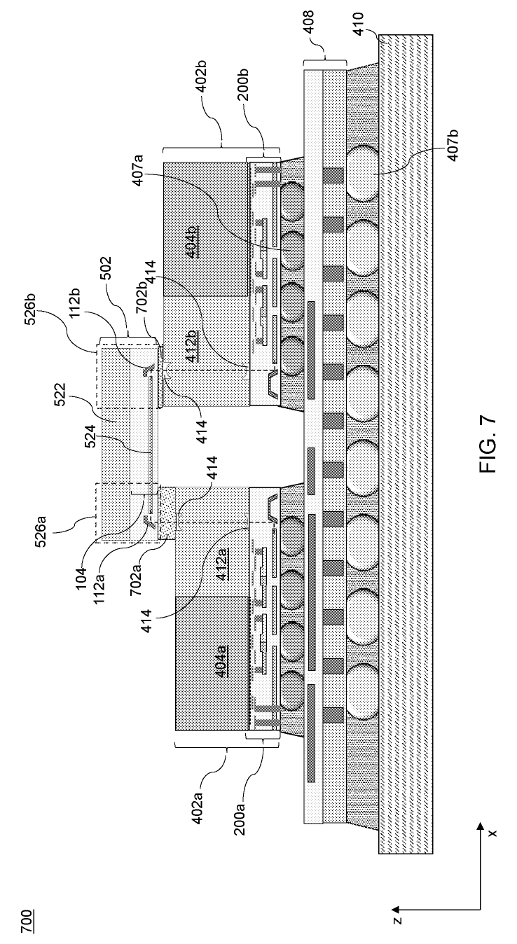

As further shown in FIG. 5B, each of the first optical engine 402a and the second optical engine 402b may be formed as separate dies and may be attached to, and electrically coupled to, the electronic interposer 408. The photonic interconnect die 502 may also be formed as a separate die and may be attached to the first optical engine 402aand the second optical engine 402b as shown, for example, in FIG. 5B. In this regard, a first portion 526a of the photonic interconnect die 502 may be mechanically and photonically coupled to the first optical engine 402a and a second portion 526b of the photonic interconnect die 502 may be mechanically and photonically coupled to the second optical engine 402b. As described in greater detail with reference to FIG. 7, below, the photonic interconnect die 502 may be coupled to the first optical engine 402aand the second optical engine 402b using an optical adhesive (702a, 702b) that may be transparent to photonic signals.

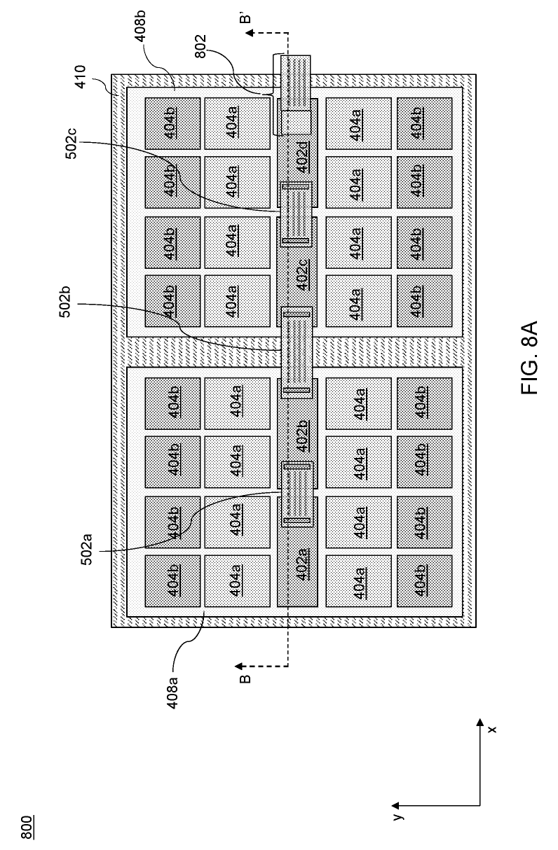

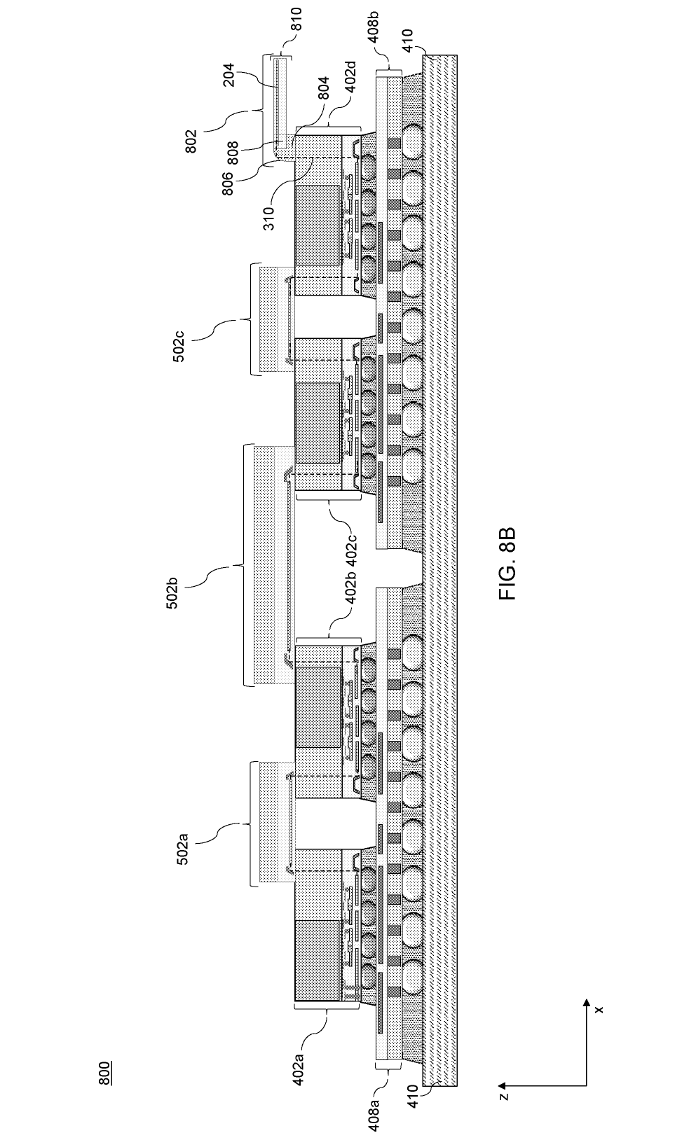

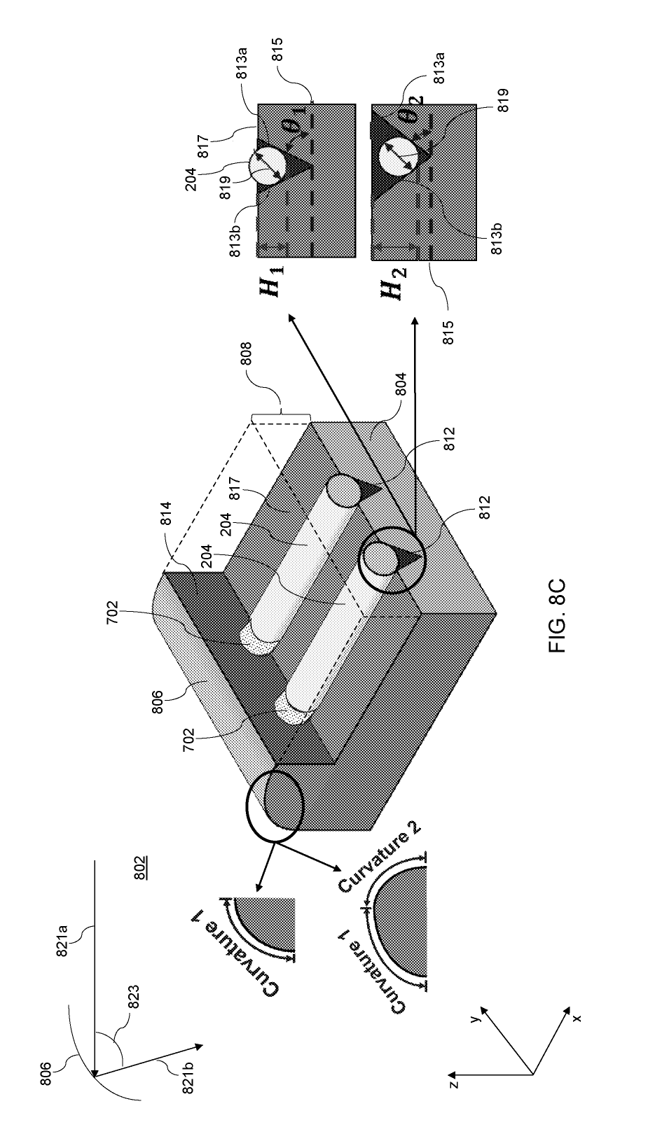

As shown in FIGS. 5A and 5B, the photonic interconnect die 502 may be configured as an intra-package photonic coupler. In this regard, the photonic interconnect die 502 may couple photonic components (402a, 402b) within a package 500 formed on a single electronic interposer 408. In other embodiments, a photonic interconnect die 502 may couple components formed on two or more different interposers, as described in greater detail with reference to FIGS. 8A and 8B, below. As such, the photonic interconnect die 502 may be configured as an inter-package photonic coupler in further embodiments.

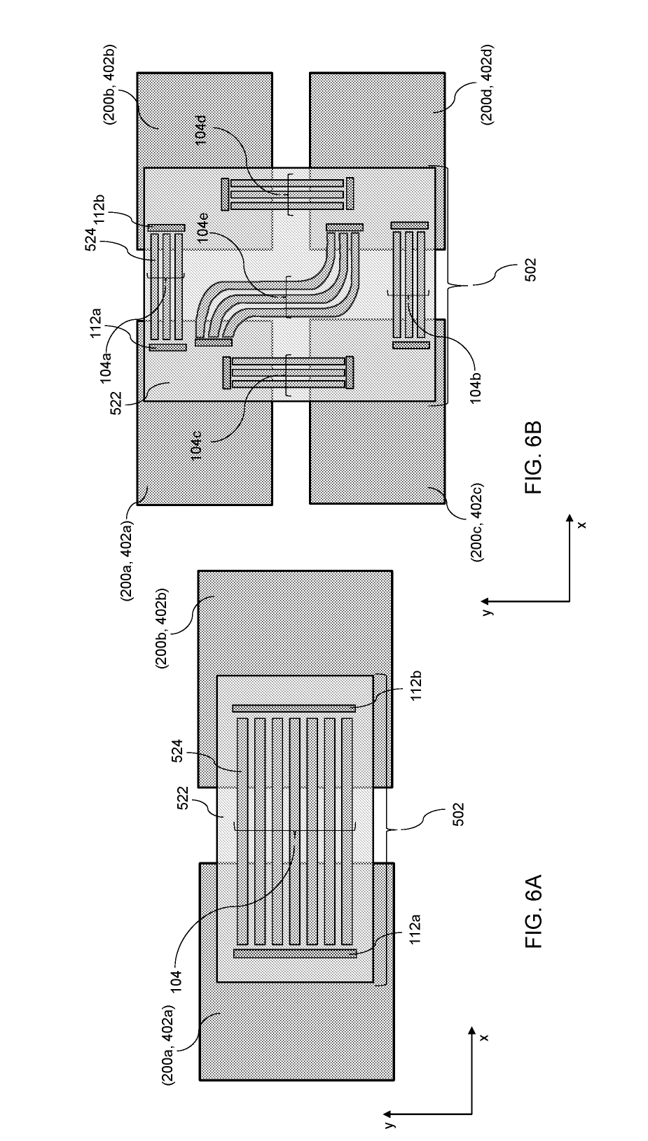

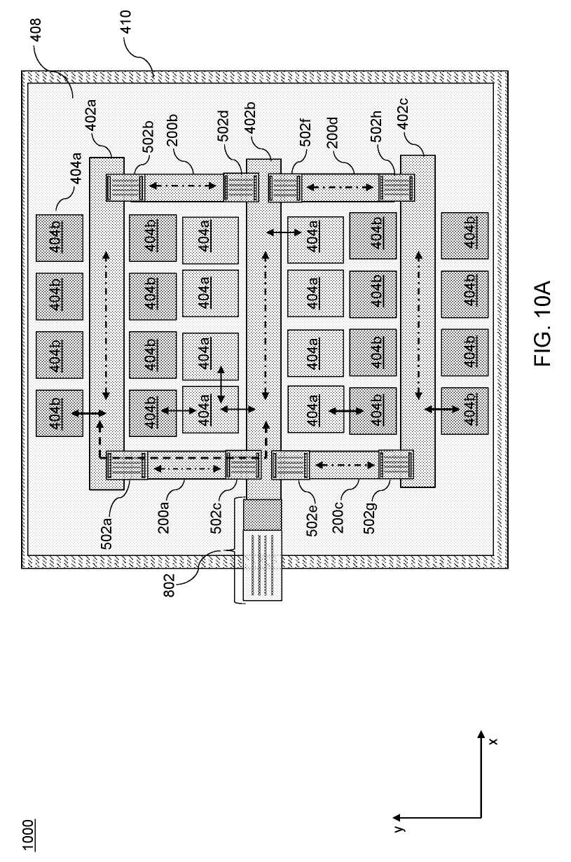

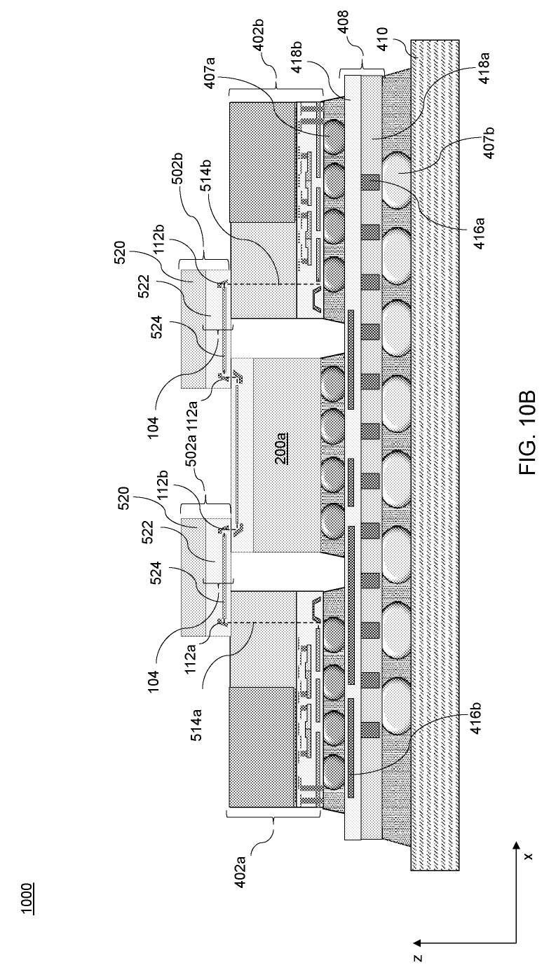

FIG. 6A is a top view of a photonic interconnect die 502 that photonically connects a first photonic component (200a, 402a) and a second photonic component (200b, 402b), according to various embodiments. In this regard, the first photonic component may be one of a first PIC 200aor a first optical engine 402a, and the second photonic component may be one of a second PIC 200b or a second optical engine 402b. An example embodiment in which the photonic interconnect die 502 couples a first optical engine 402a to a second optical engine 402b is described in greater detail with reference to FIGS. 5A and 5B, above. In a further embodiment, a first optical engine 402a may be coupled to a PIC 200, as described in greater detail with reference to FIGS. 9A, 9B, and 10, below.

As shown in FIG. 6A, the photonic interconnect die 502 may include a plurality of dielectric waveguides 104. Each of the dielectric waveguides may include a core portion 524 forming within a surrounding cladding portion 522. Each of the plurality of dielectric waveguides 104 may be photonically coupled to a first photonic coupler 112a and a second photonic coupler 112b. In this example embodiment, each of the plurality of dielectric waveguides 104 may share a common first photonic coupler 112aand a common second photonic coupler 112b. Each of the common first photonic coupler 112a and the common second photonic coupler 112b may be formed as an angled reflector 306c(e.g., see FIG. 5B). Other embodiments may include other types of photonic couplers (306a, 306b), as described in greater detail below

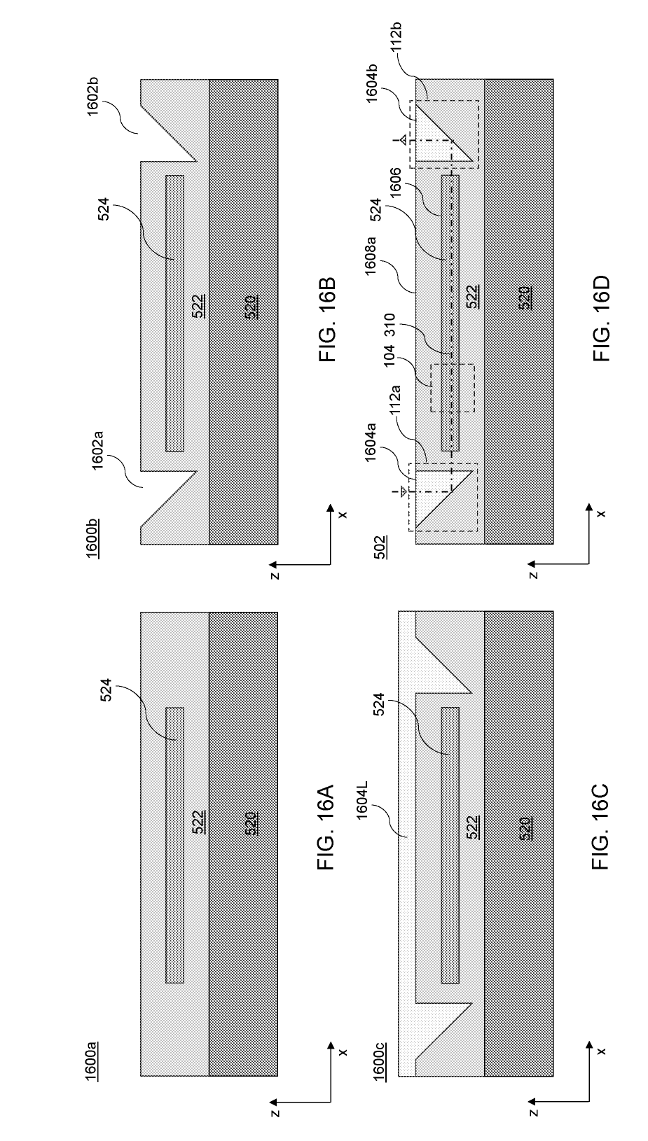

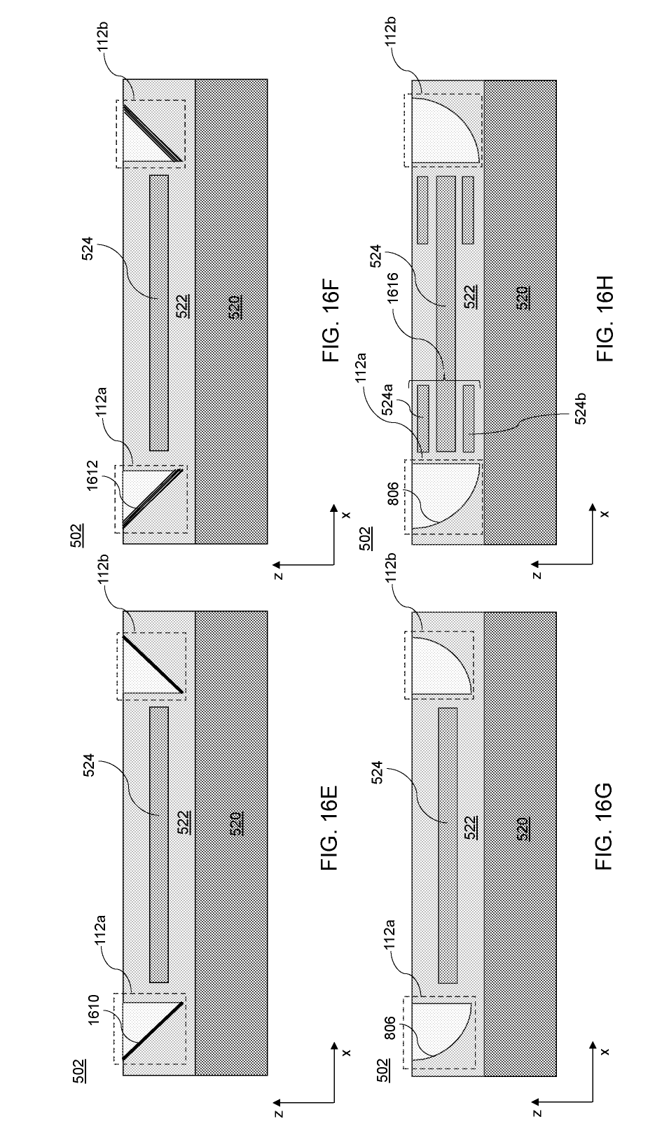

In contrast to the common first photonic coupler 112a and the common second photonic coupler 112b, in other embodiments, each of the core portions 524 may be coupled to a respective individual first photonic coupler 112a (not shown) and a respective individual second photonic coupler 112b (not shown). For example, each of the core portions 524 may be coupled to respective angled reflectors 306c that may be spatially separated from one another. Alternatively, each of the core portions 524 may be coupled to respective grating couplers 306a. The formation of angled reflectors 306c is described in greater detail with reference to FIGS. 16A - 16H, below, and the formation of grating couplers 306a is described in greater detail with reference to FIGS. 18A - 18C, below. As mentioned with reference to FIG. 5B, above, the photonic interconnect die 502 may include a substrate 520 (not shown in FIG. 6A) on which the cladding portion 522 may be formed, as described in greater detail with reference to FIGS. 14A -15C, below. While the photonic interconnect die 502 of FIG. 6A may couple two photonic components, other embodiments may couple three, four, etc., photonic components, as described in greater detail with reference to FIG. 6B, below.

FIG. 6B is a top view of a photonic interconnect die 502 that photonically connects a first photonic component (200a, 402a), a second photonic component (200b, 402b), a third photonic component (200c, 402b), and a fourth photonic component (200d, 402d), according to various embodiments. In this regard, various combinations of PICs (200a, 200b, 200c, 200d) and optical engines (402a, 402b, 402c, 402d) may be photonically coupled. As shown, the photonic interconnect die 502 may include a first plurality of dielectric waveguides 104a, a second plurality of dielectric waveguides 104b, a third plurality of dielectric waveguides 104c, a fourth plurality of dielectric waveguides 104d, and a fifth plurality of dielectric waveguides 104e.

In the example embodiment of FIG. 6B, the first plurality of dielectric waveguides 104a may photonically couple the first photonic component (200a, 402a) and the second photonic component (200b, 402b); the second plurality of dielectric waveguides 104b may photonically couple the third photonic component (200c, 402c) and the fourth photonic component (200d, 402d); the third plurality of dielectric waveguides 104c may photonically couple the first photonic component (200a, 402a) and the third photonic component (200c, 402c); the fourth plurality of dielectric waveguides 104d may photonically couple the second photonic component (200b, 402b) and the fourth photonic component (200d, 402d); and the fifth plurality of dielectric waveguides 104e may photonically couple the first photonic component (200a, 402a) and the fourth photonic component (200d, 402d).

Each plurality of dielectric waveguides (104a, 104b, 104c, 104d, 104e) may include a plurality of core portions 524 formed within a surrounding cladding portion 522. Each plurality of dielectric waveguides (104a, 104b, 104c, 104d, 104e) may also be photonically coupled to respective first photonic couplers 112a and second photonic couplers 112b. The photonic couplers (112a, 112b) may include grating couplers 306a, edge couplers 306b, and angled reflectors 306c in various embodiments (e.g., see FIGS. 3C, 3D, and 5B). As shown in FIG. 6B, the pluralities of dielectric waveguides (104a, 104b, 104c, 104d, 104e) may be configured in various ways including straight dielectric waveguides (104a, 104b, 104c, 104d) as well as curved dielectric waveguides 104e. While the photonic interconnect die 502 of FIG. 6B may couple four photonic components, other embodiments may couple three, five, six, etc., photonic components, in other embodiments.

FIG. 7 is a vertical cross-sectional view of a further electronic/photonic package 700 including a photonic interconnect die 502, according to various embodiments. As shown, the electronic/photonic package 700 may include a first optical component (e.g., first optical engine 402a) and a second optical component (e.g., second optical engine 402b). As shown, a first portion 526aof photonic interconnect die 502 may mechanically and photonically coupled to the first optical engine 402a and a second portion 526b of photonic interconnect die 502 may be mechanically and photonically coupled to the second optical engine 402b. In this regard, a first optical adhesive layer 702amay connect the first portion 526aof photonic interconnect die 502 to a first integrated optics section 412a of the first optical engine 402a, and a second optical adhesive layer 702b may connect the second portion 526bof photonic interconnect die 502 to a second integrated optics section 412b of the second optical engine 402b.

As shown, the first optical adhesive layer 702a and the second optical adhesive layer 702b may have different thicknesses to accommodate different sizes and placement/alignment errors of optical components (402a, 402b) to be joined by the photonic interconnect die 502. In this regard, the first optical adhesive layer 702a may be thicker than the second optical adhesive layer 702b. For example, the first optical engine 402a may have a smaller thickness than the second optical engine 402b. Alternatively, the first optical engine 402a and the second optical engine 402b may have a common thickness but may have a positioning tolerance that allows a certain height difference due to variations in thicknesses of the first solder material portions 407a used to bond the optical components (402a, 402b) to the electronic interposer 408.

The optical adhesive layers (702a, 702b) may be chosen to be transparent and to provide a secure mechanical connection between the photonic interconnect die 502 and the optical components (402a, 402). According to an embodiment, the optical adhesive layer (702a, 702b) may include an adhesive that is similar to materials that may be used to secure optical fibers within connectors, splices, and other components in fiber optic systems. As such, the optical adhesive layers (702a, 702b) may include a material that has optical clarity, low shrinkage, and good adhesion properties to ensure efficient light transmission between the photonic interconnect die 502 and the optical components (402a, 402).

In some embodiments, the optical adhesive layers (702a, 702b) may include an optical epoxy, which may be a two-part adhesive that includes a resin and a hardener. When mixed in the correct proportions and applied between the optical components (402a, 402b) and the photonic interconnect die 502, the optical adhesive layers (702a, 702b) may undergo a chemical reaction to cure and form a solid, transparent bond. The cured optical adhesive layers (702a, 702b) may thereby form a mechanical connection that maintains an alignment and stability of the optical components (402a, 402b) and the photonic interconnect die 502, minimizing signal loss and ensuring reliable data transmission between the photonic interconnect die 502 and the optical components (402a, 402).

Chemical compositions of optical adhesives, or optical epoxies, may vary based on the specific requirements and properties desired for different applications. According to certain embodiments, optical epoxies may include an epoxy resin, a curing agent or hardener, filler materials, plasticizers, adhesion promoters, UV stabilizers, and optical transparency agents. The epoxy resin may provide the primary structure and bonding capability. Such resins may be polymer materials formed by the reaction of an epoxide resin with a curing agent or hardener. Example epoxy resins include bisphenol A (DGEBA) and bisphenol F. The curing agent or hardener component may initiate a polymerization reaction with the epoxy resin, leading to hardening or curing of the adhesive. Amines may be used as curing agents in optical epoxies.

Fillers may be added to improve mechanical and thermal properties of the optical adhesive layers (702a, 702b). In some embodiments, fillers may also enhance the optical properties of the optical adhesive layers (702a, 702b). Example fillers may include silica or other fine particles such as carbon/graphite particles. Plasticizers may be added to improve flexibility and to reduce brittleness in the cured adhesive layers (702a, 702b). Adhesion promoters may include compounds added to enhance bonding properties to specific materials, such as glass or metal surfaces. According to some embodiments, optical epoxies used in applications that may be exposed to UV light may contain UV stabilizers to prevent degradation of the optical adhesive layers (702a, 702b) that may be caused by ultraviolet radiation. According to some embodiments, the optical adhesive layers (702a, 702b) may include optical transparency agents to maintain or enhance optical clarity. These agents may be used to ensure that the cured optical adhesive layers (702a, 702b) have low optical absorption and thereby do not introduce loss of transmitted photonic signals.

FIG. 8A is a top view of a further electronic/photonic package 800 including a first photonic interconnect die 502a, a second photonic interconnect die 502b, and a third photonic interconnect die 502c, and FIG. 8B is a vertical cross-sectional view of the electronic/photonic package of FIG. 8A, according to various embodiments. The vertical plane defining the cross-sectional view of FIG. 8B is indicated by the cross-section B – B’ in FIG. 8A. As shown in FIG. 8A, the electronic/photonic package 800 may include a plurality of first EICs 404a and a plurality of second EICs 404b. Each of the plurality of first EICs 404a may provide a first functionality and each of the plurality of second EICs 404b may provide a second functionality. For example, the plurality of first EICs 404a may be CPU dies, GPU dies, application specific integrated circuits (ASICs), etc., which may provide a functionality to perform computational logic operations. In various embodiments, the plurality of second EICs 404b may be memory (e.g., high-bandwidth memory (HBM)) dies that may provide a data storage functionality.

The electronic/photonic package 800 may further include a first electronic interposer 408a and a second electronic interposer 408b. Some of the plurality of first EICs 404a and the plurality of second EICs 404b may be attached to, and electrically coupled to, the first electronic interposer 408a and other ones of the plurality of first EICs 404a and the plurality of second EICs 404b may be attached to, and electrically coupled to, the second electronic interposer 408b. In turn, each of the first electronic interposer 408a and the second electronic interposer 408b may be attached to, and electrically coupled to, a package substrate 410. The package substrate 410 may allow the electronic/photonic package 800 to be connected to other system components such as a printed circuit board (PCB) (not shown). The first electrical interposer 408a and the second electrical interposer 408b may provide electrical connections to various ones in the plurality of first EICs 404a and the plurality of second EICs 404b.

As with other embodiments described above, the electronic/photonic package 800 may further include photonic components that may provide optical/photonic signaling functionality. For example, the electronic/photonic package 800 may include a first optical engine 402a, a second optical engine 402b, a third optical engine 402c, and a fourth optical engine 402d. Each of the first optical engine 402a, the second optical engine 402b, the third optical engine 402c, and the fourth optical engine 402d may be configured to convert electrical signals into photonic signals and vice versa, as described in greater detail with reference to FIGS. 4, 5A, and 5B, above. The first optical engine 402a and the second optical engine 402b may be attached to, and electrically coupled to, the first electronic interposer 408a. Similarly, the third optical engine 402c and the fourth optical engine 402d may be attached to, and electrically coupled to, the second electronic interposer 408b.

Each of the first optical engine 402a and the second optical engine 402b may receive electrical signals from, and may transmit electrical signals to, the first electronic interposer 408a, and each of the third optical engine 402c and the fourth optical engine 402d may receive electrical signals from, and may transmit electrical signals to, the second electronic interposer 408b. The first photonic interconnect die 502a may photonically couple the first optical engine 402a and the second optical engine 402b, and as such, may be configured as an intra-package photonic coupler. Similarly, the third photonic interconnect die 502c may also be configured as an intra-package photonic coupler that photonically couples the third optical engine 402c with the fourth optical engine 402d. In contrast, the second photonic interconnect die 502a may be configured as an inter-package photonic coupler by photonically coupling the second optical engine 402b with the third optical engine 402c. In this regard, signals may be efficiently routed between devices attached to the first electrical interposer 408a and devices attached to the second electrical interposer 408b.

As shown in FIGS. 8A and 8B, the electronic/photonic package 800 may further include a fiber array unit (FAU) 802. The FAU 802 may couple photonic signals into and out of the fourth optical engine 402b. As shown in FIG. 8B, the FAU 802 may include a housing 804 having a curved reflector surface 806 and a fiber coupler section 808. A fiber optic cable 810 may be mechanically and photonically coupled to the fiber coupler section 804. As such, optical fibers 204 within the fiber optic cable 810 may be photonically coupled to the housing 804 that a photonic signal 310 propagating vertically within the fourth optical engine 402d may be reflected by the curved reflector surface 806 into the fiber coupler 804. The photonic signal 310 received from the fourth optical engine 402d may then be transmitted into one or more of the optical fibers 204 within the fiber optic cable 810. Similarly, photonic signals 310 received from the fiber optic cable 810 may be reflected by the curved reflector surface 806 into the fourth optical engine 402d.

FIG. 8C is a three-dimensional perspective view showing details of the FAU 802 of FIG. 8B, according to various embodiments. As shown, the housing 804 may include a curved reflector surface 806. Optical fibers 204 may be placed in respective grooves 812 formed in the housing 804 in the fiber coupler section 808. An optical adhesive 702 may be formed between ends of the optical fibers 204 and a coupling surface 814 of the housing 804. The housing 804 may be formed of a polymer material that may be patterned and etched using semiconductor manufacturing techniques. For example, the curved reflector surface 806 may be formed by patterning and etching the polymer material of the housing 804 using multi-tone masks and low contrast photoresists, according to various embodiments.

The dashed region of the fiber coupler section 808 may also be formed by removing a portion of the polymer material forming the housing 804 using patterning and etching techniques. Similarly, the grooves 812 that secure the optical fibers may be generated by performing an etching process. As shown in FIG. 8B, the optical fibers 204 may be provided in a fiber optic cable 810 (omitted in FIG. 8C for clarity). Once the optical fibers 204 are secured within the grooves of the housing 804, an additional polymer material (not shown) may be formed over the optical fibers 204 within a volume indicated by the dashed region of the fiber coupler section 808. The use of a single angled reflector surface 806 for a plurality of optical fibers 204 allows multiple optical fibers 204 to be closely spaced without a need for tight alignment tolerances that may otherwise be required if each optical fiber 204 was to be aligned with its own respective reflector.

As further shown in FIG. 8C, the grooves 812 may be formed to have internal surfaces (813a, 813b) that may be angled relative to a plane 815 parallel to a surface 817 of the housing 804. In this regard, a first surface 813a may subtend a first angle θ₁ relative to the plane 815. A second surface 813bmay have a similar angle (not shown) relative to the plane 815. A fixed diameter 819 optical fiber 204 may be seated within the groove 812 to a depth H₁ relative to the surface 817 of the housing 804, such that the depth H₁ is a geometric function of the first angle θ₁. Alternatively, in a further embodiment, a groove may be wider and may therefore be characterized by a second angle θ₂ (with θ₂ > θ₁) measured relative to the plane 815. In this example, the wider groove may accommodate a fixed diameter 819 optical fiber 204 to a depth H₂ that is greater than the depth H₁ of the first groove. The depth H₂ is given by the same geometric function of the second angle θ₂ as the function that determines the first depth H₁ as a function of the first angle θ₁. The first depth H₁ and the second depth H₂ measure a vertical position of the optical fiber 812 relative to the surface 817. Thus, the vertical positioning of the optical fiber 204 may be designed to have a pre-determined depth by forming the groove 812 to having internal surfaces (813a, 813b) that subtend corresponding pre-determined angles relative to the horizontal plane 815.

Similarly, as further shown in FIG. 8C, a curvature of the curved reflector surface 806 may be chosen to provide a certain pre-determined reflectivity of a photonic signal provided by the optical fibers 204. In this regard, an incident photonic signal 821a may impinge on the curved reflector 806 and may be reflected to thereby generate a reflected photonic signal 821b. As shown, the reflected photonic signal 821b may propagate away from the curved reflector surface 806 at an angle 823 relative to the incident photonic signal 821a. The reflected angle 823 may depend on an angle of incidence (not explicitly shown) between the incident photonic signal 821a and the curved reflector surface 806. The reflected angle 823 may further depend on a curvature (i.e., a radius of curvature) of the curved reflector surface 806. Thus, a pre-determined refection characteristic (e.g., a reflection angle 823) may be determined by choosing the curvature of the curved reflector surface 806 to have a certain pre-determined value (i.e., local radius of curvature). As such, the coupling between the optical fibers 204 and the FAU 802 may be determined by the curvature of the curved reflector surface 806, as well as by adjusting a vertical position of the optical fibers 204, as described above.

In some embodiments, the curved reflector surface 806 may have a single curvature (e.g., labeled “Curvature 1”) or may have a variable curvature. A single curvature means a single value of a radius of curvature that characterizes the entire surface. In other embodiments, the surface may have a curvature (i.e., radius of curvature) that varies along the surface. In one example, a surface may a have a first portion having a first radius of curvature (e.g., labeled “Curvature 1”) and a second portion having a second radius of curvature (e.g., labeled “Curvature 2”), according to further embodiments. In still-further embodiments, the curved reflector surface 806 may have a radius of curvature that varies continuously (not shown) as a function of position on the curved reflector surface 806. In other embodiments, the radius of curvature may be a piecewise-smooth function of position (not shown) on the curved reflector surface 806 (i.e., may include N segments each corresponding to N different respective curvatures, where N is an integer).

FIG. 9A is a top view of a further electronic/photonic package 900 including a plurality of photonic interconnect dies (502a, 502b, 502c, 502d, 502e, 502f, 502g, 502h), according to various embodiments. The electronic/photonic package 900 may include a plurality of first EICs 404a and a plurality of second EICs 404b. Each of the plurality of first EICs 404a may provide a first functionality (e.g., logic operations) and each of the plurality of second EICs 404b may provide a second functionality (e.g., data storage operations).

Each of the plurality of first EICs 404a and the plurality of second EICs 404b may be attached to, and electrically coupled to, an electronic interposer 408. The electronic interposer 408 may, in turn, be attached to, and electrically coupled to, a package substrate 410. The electronic interposer 408 may provide electrical connections between the plurality of first EICs 404a and the plurality of second EICs 404b. As such, the electronic interposer 408 may provide power to the various components of the electronic/photonic package 900 and may further provide electrical signal pathways between the components of the electronic/photonic package 900. The package substrate 410 may allow the electronic/photonic package 500 to be connected to other system components such as a printed circuit board (PCB) (not shown).

As shown in FIG. 9A, some of the first EICs 404a may be attached to, and electrically coupled to, an active interposer 902. The active interposer may provide electrical connections between neighboring first EIC 404a and may further include active circuit components. For example, the active interposer 902 may include transistors that may provide additional logic processing operations and/or data storage functionality. Some of the second EICs 404b may further be co-packaged with one or more first EICs 404a to form a stacked structure 904. In this regard, the stacked structure 904 may include a second EIC 404b stacked on top of a first EIC 404a. For example, a the second EIC 404b may be bonded to the first EIC 404a in the stacked structure 904 using hybrid bonding structures (not shown). In this regard, the first EIC 404a may provide control circuitry for the second EIC 404b, which may provide a data storage functionality.

To reduce signal delay and ohmic loss, the electronic/photonic package 900 may further include photonic components that may provide optical/photonic signaling functionality. For example, the electronic/photonic package 900 may include a plurality of PICs (200a, 200b, 200c, 200d, 200e, 200f, 200g). Signal pathways within the electronic/photonic package 900 may thus include both electronic signal pathways (e.g., see solid arrows) as well as photonic signal pathways (e.g., see dot-dashed arrows). As shown in FIG. 9A, electronic signal pathways may exist between neighboring first EICs 404a, between first EICs 404a and second EICs 404b, between first EICs 404a and one or more PICs (200a, 200b, 200c, 200d, 200e, 200f, 200g) and between second EICs 404b and one or more PICs (200a, 200b, 200c, 200d, 200e, 200f, 200g).

In addition to reducing ohmic loss by providing photonic signaling pathways, one or more of the plurality of PICs (200a, 200b, 200c, 200d, 200e, 200f, 200g) may provide a functionality to perform (classical or quantum) logic operations directly on photonic signals. As such, various ones of the plurality of PICs (200a, 200b, 200c, 200d, 200e, 200f, 200g) may provide respective functionalities and may have respective structural configurations. For example, some of the PICs (200d, 200e, 200f, 200g) may be smaller than other PICs (200a, 200b, 200c) and may have more limited functionality than that of the larger PICs (200a, 200b, 200c). For example, the smaller PICs (200d, 200e, 200f, 200g) may be configured as photonic transceivers, as described with reference to FIG. 2, above.

Alternatively, the larger PICs (200a, 200b, 200c) may be configured as monolithic electronic/photonic devices that may perform a variety of functions including photonic signal generation and photonic signal processing. For example, the monolithic PICs (200a, 200b, 200c) may receive electrical signals from neighboring EICs (404a, 404b) as well as photonic signals from neighboring PICs (200d, 200e, 200f, 200g) and may perform a variety of processing operations on the received signals. The electronic/photonic package 900 may further include an FAU 802 that may be configured to transmit and receive photonic signals. As shown, the FAU 802 may provide a photonic interface between one of the PICs (e.g., PIC 200b) and with external photonic circuits (not shown). The FAU 802 may be configured similarly to that of the FAU 802 described above with reference to FIGS. 8B and 8C and may provide similar photonic signaling functionality.

FIG. 9B is a vertical cross-sectional view of a portion of the electronic/photonic package 900 of FIG. 9A, according to various embodiments. The vertical plane defining the cross-sectional view of FIG. 9B is indicated by the cross-section B – B’ in FIG. 9A. As shown, the portion of the electronic/photonic package 900 of FIG. 9A includes a first photonic interconnect die 502a and a second photonic interconnect die 502b. The first photonic interconnect die 502a may photonically connect a first PIC 200a with a second PIC 200d. Similarly, the second photonic interconnect die 502b may photonically connect the second PIC 200d with a third PIC 200c. As described above, the various PICs (200a, 200c, 200d) may have respective configurations and may provide respective functionalities. For example, the second PIC 200c may have relatively limited functionality and may, for example, be configured as a photonic transceiver, as described above with reference to FIG. 2. In contrast, the first PIC 200a and the third PIC 200c may be formed as monolith structures that may provide more complex functionality including. for example, computing and logic operations on photonic data.

FIG. 10A is a top view of a further electronic/photonic package 1000 including a plurality of photonic interconnect dies (502a, 502b, 502c, 502d, 502e, 502f, 502g, 502h), and FIG. 10B is a vertical cross-sectional view of a portion of the electronic/photonic package 1000 of FIG. 10A, according to various embodiments. The vertical plane defining the cross-sectional view of FIG. 10B is indicated by the cross-section B – B’ in FIG. 10A. The electronic/photonic package 1000 may be similar to the electronic/photonic package 900 of FIGS. 9A and 9B. In this regard, the electronic/photonic package 1000 may include a plurality of first EICs 404a and a plurality of second EICs 404b. Each of the plurality of first EICs 404a may provide a first functionality (e.g., logic operations) and each of the plurality of second EICs 404b may provide a second functionality (e.g., data storage operations).

Each of the plurality of first EICs 404a and the plurality of second EICs 404b may be attached to, and electrically coupled to, an electronic interposer 408. The electronic interposer 408 may, in turn, be attached to, and electrically coupled to, a package substrate 410. The electronic interposer 408 may provide electrical connections between the plurality of first EICs 404a and the plurality of second EICs 404b. As such, the electronic interposer 408 may provide power to the various components of the electronic/photonic package 900 and may further provide electrical signal pathways between the components of the electronic/photonic package 900. The package substrate 410 may allow the electronic/photonic package 500 to be connected to other system components such as a printed circuit board (PCB) (not shown).

In contrast to the electronic/photonic package 900 of FIGS. 9A and 9B, the electronic/photonic package 1000 may omit the active interposer 902 and the stacked structure 904. As such, all of the first EICs 404aand the second EICs 404b may be attached, and electrically coupled, directly to the electronic interposer 408. As such, the electronic/photonic package 1000 may be simpler in terms of electrical connections formed between the various EICs (404a, 404b) and the electrical interposer 408. The relative simplicity of the electronic/photonic package 900 of FIGS. 9A and 9B may be advantageous for certain applications.

As with the electronic/photonic package 900 of FIGS. 9A and 9B, the electronic/photonic package 1000 of FIGS. 10A and 10B may further include photonic components that may provide optical/photonic signaling functionality. For example, the electronic/photonic package 1000 may include a plurality of PICs (200a, 200b, 200c, 200d) and optical engines (402a, 402b, 402c). Signal pathways within the electronic/photonic package 1000 may thus include both electronic signal pathways (e.g., see solid arrows) as well as photonic signal pathways (e.g., see dot-dashed arrows). As shown in FIG. 10A, electronic signal pathways may exist between neighboring first EICs 404a, between first EICs 404a and second EICs 404b, between first EICs 404a and one or more optical engines (402a, 402b, 402c) and between second EICs 404b and one or more optical engines (402a, 402b, 402c).

As with the electronic/photonic package 900 of FIGS. 9A and 9B, one or more of the plurality of PICs (200a, 200b, 200c, 200d) may provide a functionality to perform (classical or quantum) logic operations directly on photonic signals, in addition to reducing ohmic loss by providing photonic signaling pathways. As such, various ones of the plurality of PICs (200a, 200b, 200c, 200d) may provide respective functionalities and may have respective structural configurations. For example, some of the PICs (200a, 200b, 200c, 200d) may have more limited functionality than that of other ones of the PICs (200a, 200b, 200c, 200d). For example, some of the PICs (200a, 200b, 200c, 200d) may be configured as photonic transceivers, as described with reference to FIG. 2, above. Alternatively, other ones of the PICs (200a, 200b, 200c, 200d) may be configured to perform a variety of functions including photonic signal generation and photonic signal processing.

In contrast to other embodiments described above (e.g., see FIGS. 4 - 5B), the optical engines (402a, 402b, 402c) may be larger and may be configured to provide additional functionality to other optical engines described above. In this regard, the optical engines (402a, 402b, 402c) of FIGS. 10A and 10B may be larger, monolithic devices that may provide enhanced functionality. In this regard, the optical engines (402a, 402b, 402c) of FIGS. 10A and 10B may be configured to be electrically connected to a plurality of first EICs 404a and second EICs 404b in addition to being photonically coupled with two or more PICs. For example, as shown in FIG. 10A, a first monolithic optical engine 402a may be electronically coupled to second EICs 404b that are attached to the electronic interposer 408 adjacent to the first monolithic optical engine 402a.

Further, the first monolithic optical engine 402a may be photonically coupled to a first PIC 200a and a second PIC 200b. Thus, according to certain embodiments, photonic logic operations may be performed by the first PIC 200a and the second PIC 200b and the results of the photonic computations may be provided to the first monolithic optical engine 402a by a first photonic interconnect die 502a and a second photonic interconnect die 502b, respectively. The photonic signals received by the first monolithic optical engine 402a may then be converted to corresponding electrical signals that encode data representing the results of the logic operations performed by the first PIC 200a and the second PIC 200b. In turn, the data may then be provided to one or more data storage devices provided by the second EICs that are adjacent to the first monolithic optical engine 402a, which may store the corresponding data.

The electronic/photonic package 1000 may further include an FAU 802 that may be configured to transmit and receive photonic signals. As shown, the FAU 802 may provide a photonic interface between one of the second monolithic optical engine 402b and external photonic circuits (not shown). The FAU 802 may be configured similarly to that of the FAU 802 described above with reference to FIGS. 8B and 8C and may provide similar photonic signaling functionality.

FIG. 10B is a vertical cross-sectional view of a portion of the electronic/photonic package 1000 of FIG. 10A, according to various embodiments. The vertical plane defining the cross-sectional view of FIG. 10B is indicated by the cross-section B – B’ in FIG. 10A. As shown, the portion of the electronic/photonic package 1000 of FIG. 10A includes a first photonic interconnect die 502a and a second photonic interconnect die 502b. The first photonic interconnect die 502a may photonically connect the first monolithic optical engine 402a with a first PIC 200a. Similarly, the second photonic interconnect die 502b may photonically connect the first PIC 200a with the second monolithic optical engine 402b.

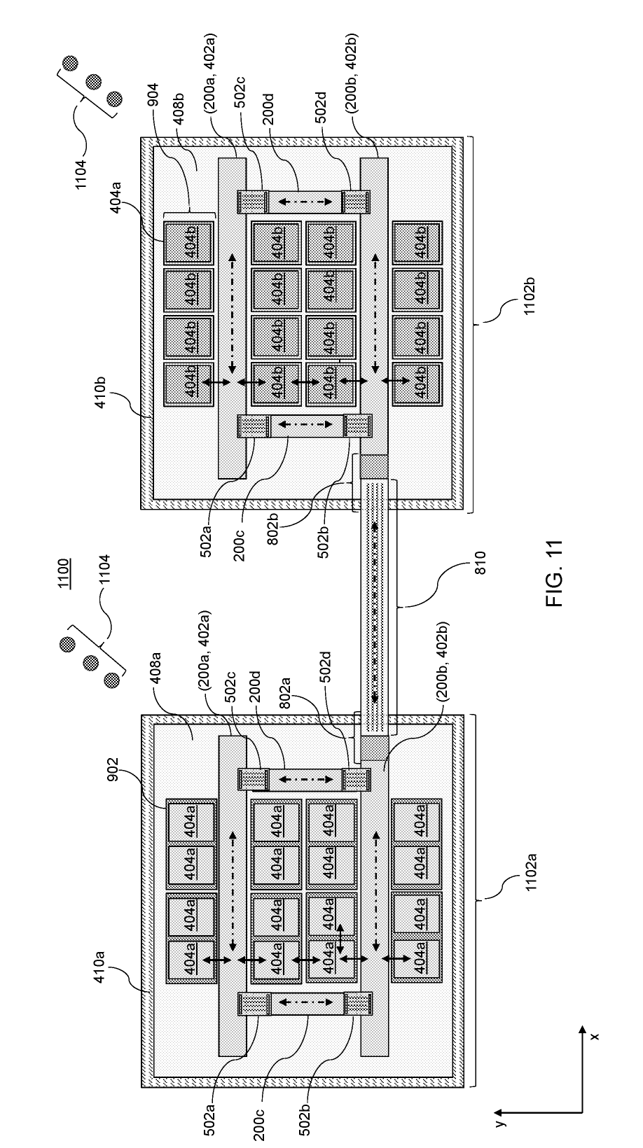

FIG. 11 is a top view of a further electronic/photonic package 1100 including a first component package 1102a and a second component package 1102b, according to various embodiments. The first component package 1102amay include a plurality of first EICs 404a attached to a first electronic interposer 408a and the second component package 1102b may include a plurality of second EICs 404b. As shown, the first electronic interposer 408a may be attached to a first package substrate 410a and the second electronic interposer 408b may be attached to a second package substrate 410b. The first component package 1102a may be optimized to perform computational logic operations and the second package component 1102b may be optimized to perform data storage and retrieval operations.

In this regard, the plurality of first EICs 404a, of the first component package 1102a, may be CPU dies, GPU dies, application specific integrated circuits (ASICs), etc., and the plurality of second EICs 404b, of the second package component 1102b, may be memory (e.g., high-bandwidth memory (HBM)) dies that may provide a data storage functionality. As described with reference to FIGS. 9A and 9B, one or more of the first EICs 404a of the first component package 1102a may be attached to an active interposer 902, and one or more of the second EICs 404b of the second package component 1102b may be attached to a first EIC 404a in a stacked structure 904. Alternative embodiments may omit the active interposer 902 and the EIC 404aof the stacked structure 904.

Each of the first component package 1102a and the second component package 1102b may further include photonic components that may provide optical/photonic signaling functionality. For example, each of the first component package 1102a and the second component package 1102b may include one or more PICs (200a, 200b, 200c, 200d) and one or more optical engines (402a, 402b). As such, each of the first component package 1102a and the second component package 1102b may include electronic signaling pathways (e.g., see solid arrows) and photonic signaling pathways (e.g., see dot-dashed arrows).

As described above, the various PICs (200a, 200b, 200c, 200d) may have different configurations and may provide respective functionalities. For example, some of the PICs (200a, 200b) may be configured as monolithic PICs, as described in greater detail with reference to FIGS. 9A and 9B, while other ones of the PICS (200c, 200d) may have a simpler structure and may perform respective functions. Further, as described with reference to FIGS. 10A and 10B, one or both of the first component package 1102a and the second component package 1102b may include one or more monolithic optical engines (402a, 402b). As described above, the one or more monolithic optical engines (402a, 402b) may be configured to interact with multiple EICs (404a, 404b) and may convert electronic signals to photonic signals and vice-versa.

As further shown in FIG. 11, the first component package 1102a and the second component package 1102b may be photonically coupled to one another by a fiber optic cable 810. In this regard, the first component package 1102a may include a first FAU 802a that is coupled to a first end of the fiber optic cable 810 and the second component package 1102b may include a second FAU 802b that may be coupled to a second end of the fiber optic cable 810. Data may be transferred between the first component package 1102a and the second component package 1102b by way of the fiber optic cable 810. As shown, the first FAU 802a and the second FAU 802b may be photonically coupled to respective monolithic PICs 200b or optical engines 402b.

Data generated by the first component package 1102a as a result of computational logic processes performed by the first EICs 404a may be transferred to the second component package 1102b in the form of photonic signals. Such photonic signals received by the second component package 1102b may then be converted to electrical signals and may be provided to the second EICs 404b for storage as digital data. Similarly, data stored on the second EICs 404b of the second component package 1102b may be retrieved and sent to the first component package 1102a as needed for ongoing logic operations being performed by the first EICs 404a of the first component package 1102a.

As indicated by the ellipsis 1104 in FIG. 11, the first component package 1102a and the second component package 1102b may represent one repeat unit in an electronic/photonic package 1100 including multiple component packages. As such, a plurality of first component packages 1102a may form a pool of computational resources that may perform logic operations. Similarly, a plurality of second component packages 1102b may provide a pool of memory resources that may perform data storage and retrieval operations.

FIG. 12 is a vertical cross-sectional view of a further electronic/photonic package 1200 including a photonic interconnect die 502 having edge couplers 306b, according to various embodiments. As shown, the electronic/photonic package 1200 may include a first optical engine 402a and a second optical engine 402b. Each of the first optical engine 402a and the second optical engine 402b may be attached to, and electrically coupled to, an electronic interposer 408. The electronic interposer 408 may be further attached to, and electrically coupled to, a package substrate 410.

The photonic interconnect die 502 may include a substrate 520 and a cladding layer 522 formed over the substrate 520. The photonic interconnect die 502 may further include a core portion 524 formed within cladding portion 522 such that that core portion 524 and the cladding portion 522 form a dielectric waveguide 104. As in other embodiments, described above, the core portion 524 may be chosen to be a dielectric material having a larger index of refraction than that of the cladding portion 522. As such, photonic signals may preferentially propagate within the core portion 524 of the dielectric waveguide.

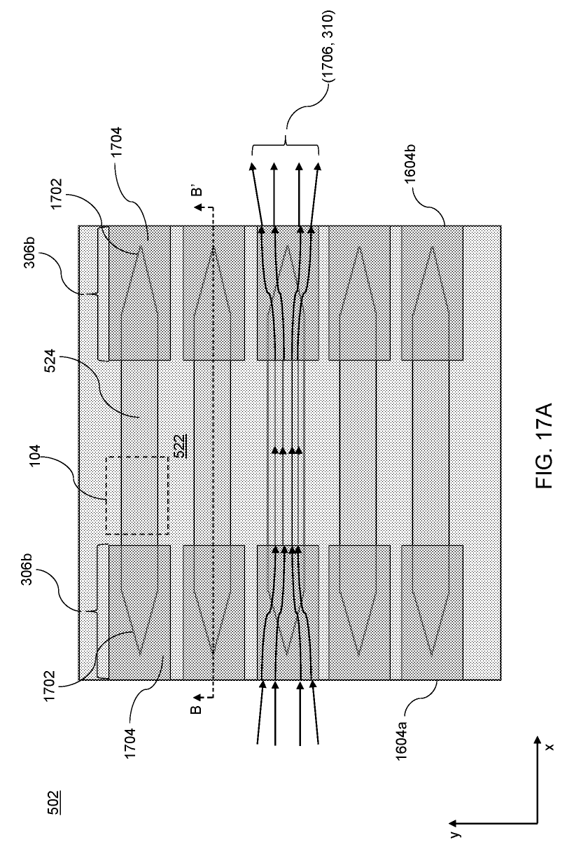

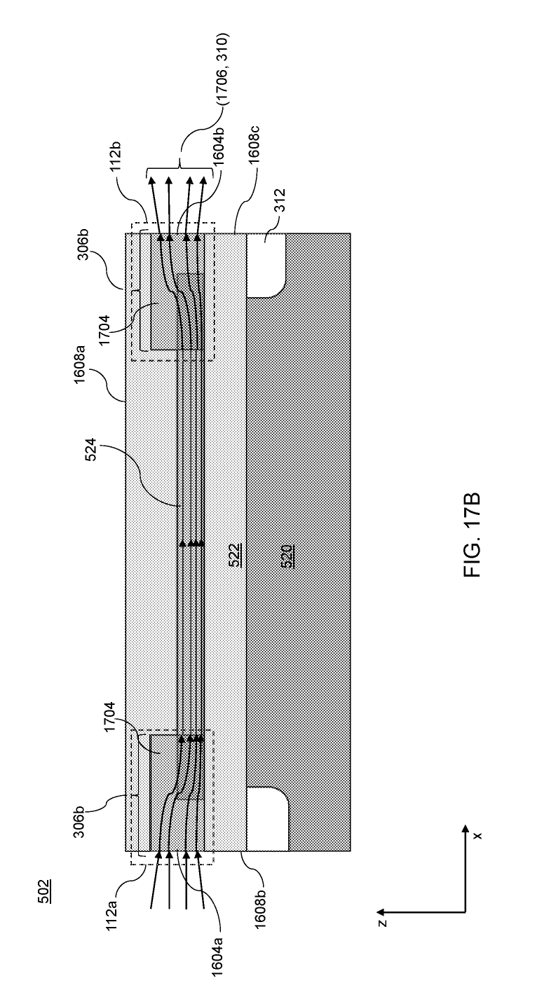

In contrast to embodiments described above (e.g., see FIG. 5B), however, the photonic interconnect die 502 may be configured such that the photonic signals may be coupled into and out from the photonic interconnect die 502 by way of edge couplers 306b. As described with reference to FIG. 3D, above, an edge coupler 306b may include a flat surface of the waveguide 104 such that photonic signals may be coupled into and out of ends of the dielectric waveguide 104. In some embodiments, the edge couplers 306b may further include a spot size converter (e.g., see FIGS. 17A and 17B) that allows a lateral size of an optical mode to be increased such that photonic signals may be efficiently coupled between a dielectric waveguide 104 and an optical fiber (also not shown).

As shown in FIG. 12, the photonic interconnect die 502 may be formed such that the substrate 520 has a first width 1202a that is larger than a second width 1202b of dielectric waveguide 104. As such, the photonic interconnect die 502 may be placed such that respective edges of the substrate 520 may be placed in contact with respective top edges of the first optical engine 402a and the second optical engine 402b. In this regard, the photonic interconnect die 502 may be mechanically supported but the top edges of the first optical engine 402a and the second optical engine 402b. As shown, side edges of the core portion 524 and the cladding portion 522 may contact respective side edges of the first optical engine 402a and the second optical engine 402b. As such, photonic signals may be coupled from the optical engines (402a, 402b) into the photonic interconnect die 502 and vice-versa using an edge-coupling configuration (i.e., with edge couplers 306b).

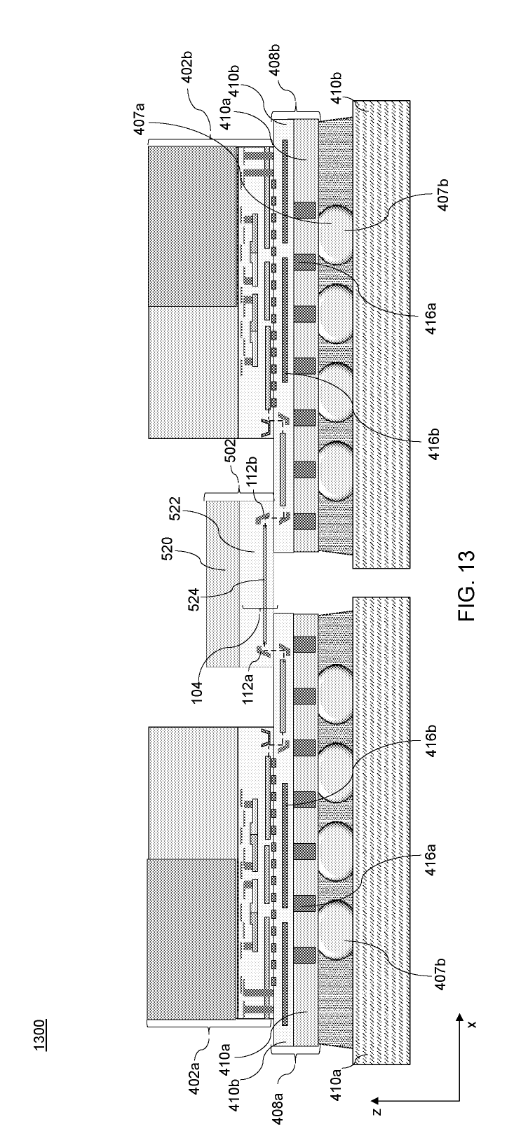

FIG. 13 is a vertical cross-sectional view of a further electronic/photonic package including a photonic interconnect die 502 that couples photonic signals between two hybrid interposers (408a, 408b), according to various embodiments. As shown, the electronic/photonic package 1300 may include a first optical engine 402a and a second optical engine 402b. Each of the first optical engine 402a and the second optical engine 402b may be attached to, and electrically coupled to, respective interposers (408a, 408b). Each of the interposers (408a, 408b) may be further attached to, and electrically coupled to, respective package substrates (410a, 410b).

As shown in FIG. 13, each of the interposers (408a, 408b) may be configured as hybrid interposers (408a, 408b) that include both electronic signal pathways and photonic signal pathways. In this regard, each the hybrid interposers (408a, 408b) may be similar to a PIC 200 (e.g., see FIG. 2 and related description) and may include passive components, such as dielectric waveguides 104, as well as active components such as photonic sources 102, detectors 106, and modulators 108 (e.g., see FIG. 1 and related description). As such, the photonic interconnect die 502 may be attached to respective surfaces of the hybrid interposers (408a, 408b). In this regard, photonic signals may be routed from the first hybrid interposer 408a, through the photonic interconnect die 502, and into the second hybrid interposer 408b, and vice-versa.

FIGS. 14A - 14D are vertical cross-sectional views of respective intermediate structures (1400a to 1400d) that may be used to form a photonic interconnect die 502, according to various embodiments. The intermediate structure 1400a of FIG. 14A may include a substrate 520, a cladding portion 522 formed over the substrate 520, and a core material layer 524L formed over the cladding portion. According to various embodiments, the cladding portion 522 and the core material layer 524L may each be dielectric materials such that the core material layer 524L has an index of refraction that is greater than that of the cladding portion 522. For example, the core material layer 524L may be a silicon layer and the cladding portion 522 may be silicon oxide. The substrate 520 may be any suitable substrate that may provide mechanical support for the cladding portion 522 and the core material layer 524L. In alternative embodiments, the cladding portion 522 and the core material layer 524L may each be polymer materials that may be chosen such that the index of refraction of the core material layer 524L is greater than that of the cladding material layer 524L.

As shown in FIGS. 14A and 14B, the intermediate structures 1400a and 1400b may further include a patterned photoresist 1402 formed over the core material layer 524. The patterned photoresist 1402 may be formed by depositing a blanket layer of photoresist (not shown) over the core material layer 524L. The blanket layer of photoresist may then be patterned using lithographic techniques to form the patterned photoresist 1402. The patterned photoresist 1402 may then be used as an etch mask during an etching process that may be used to etch the core material layer 524L. As shown in FIG. 14B, a plurality of core portions 524 may be formed upon performing such an etching process. As shown in FIG. 14C, the patterned photoresist 1402 may then be removed by ashing or dissolution in a solvent leaving the plurality of core portions 524 formed over the cladding portion 522.

As shown in FIG. 14D, an additional layer of cladding material may then be deposited over the plurality of core portions 524 to extend a thickness of the cladding portion 522. In this regard, the additional material that is deposited may thereby surround the core portions 524 such that the core portions 524 are formed within the cladding portion. As such, each of the core portions 524 may thereby form core portions 524 of respective dielectric waveguides 104.

FIG. 14E is a top view of a further intermediate structure 1400e that may be used to form a photonic interconnect die 502, according to various embodiments. As shown in FIG. 14E, each of the core portions 524 may extend along a first direction (i.e., the x-direction). The core portions 524 may further be separated from one another along a second direction (i.e., the y-direction) that is perpendicular to the first direction. As such, each core portion 524, along with a surrounding part of the cladding portion 522 may form a dielectric waveguide.

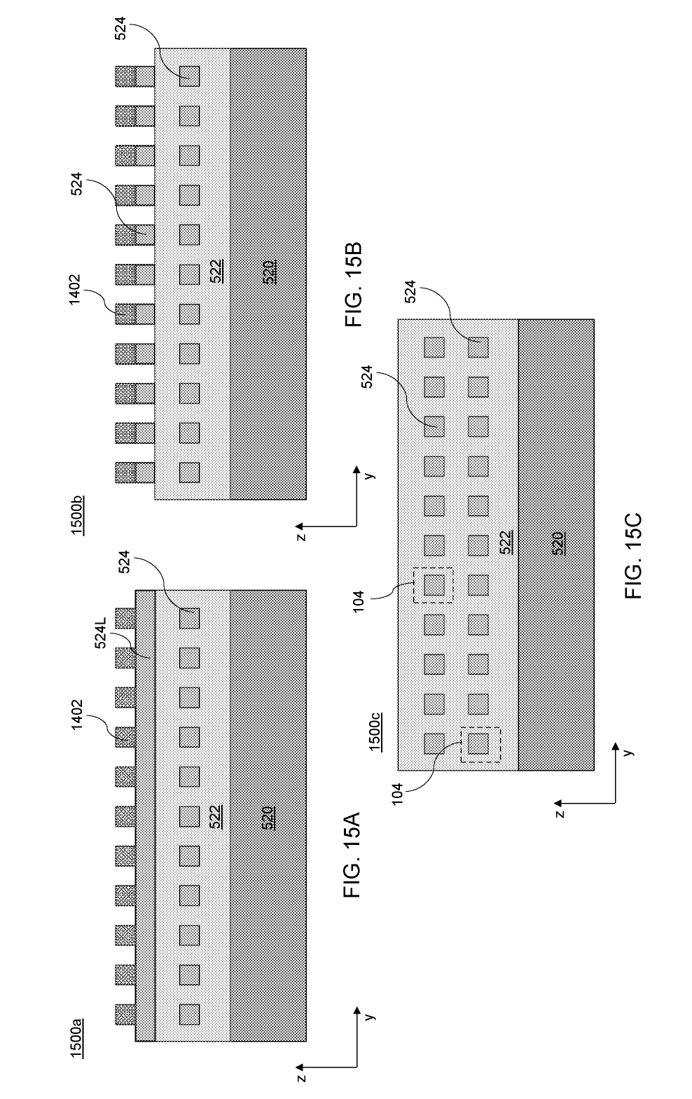

FIGS. 15A - 15C are vertical cross-sectional views of respective intermediate structures (1500a to 1500c) that may be used to form a photonic interconnect die 502, according to various embodiments. The intermediate structure 1500a of FIG. 15A may be formed by depositing an additional core material layer 524L over the intermediate structure 1400d of FIG. 14D followed by forming a patterned photoresist 1402 over the additional core material layer 524L. In this regard, the patterned photoresist 1402 may be formed by depositing a blanket layer of photoresist (not shown) over the additional core material layer 524L. The blanket layer of photoresist may then be patterned using lithographic techniques to form the patterned photoresist 1402. The patterned photoresist 1402 may then be used as an etch mask during an etching process that may be used to etch the core material layer 514L. As shown in FIG. 15B, an additional plurality of core portions 524 may be formed upon performing such an etching process. The patterned photoresist 1402 may then be removed by ashing or dissolution in a solvent leaving the plurality of core portions 524 formed over the cladding portion 522.

As shown in FIG. 15C, an additional layer of cladding material may then be deposited over the plurality of core portions 524 to extend a thickness of the cladding portion 522. In this regard, the additional material that is deposited may thereby surround the additional core portions 524 such that the core portions 524 are formed within the cladding portion 522. As such, each of the additional core portions 524 may thereby form core portions 524 of respective dielectric waveguides 104. Thus, a plurality of dielectric waveguides 104 may be formed in a three-dimensional configuration, by repeating the processes described above with reference to FIGS. 14A -15C.

FIGS. 16A - 16C are vertical cross-sectional views of respective intermediate structures (1600a to 1600c) that may be used to form a photonic interconnect die 502, according to various embodiment, and FIG. 16D is a vertical cross-sectional view of a photonic interconnect die 502 formed by processes described with reference to FIGS. 16A - 16C, according to various embodiments. The intermediate structure 1600amay include a core portion 524 formed within a cladding portion 522. As described above with reference to FIGS. 14A - 15C, the core portion 524 may be one of a plurality of core portions 524. As shown in FIG. 16B, a first angled trench 1602a and a second angled trench 1602b may be formed in the cladding portion 522. The first angled trench 1602a and the second angled trench 1602b may be formed by performing an etch process to etch the cladding portion 522. In this regard, multi-tone masks may be used to perform an etch process that generates angled surfaces.

A dielectric material layer 1604L may then be deposited over the intermediate structure 1600b to thereby form the intermediate structure 1600c of FIG. 16C. A planarization process (e.g., chemical mechanical planarization) may then be performed to remove an excess portion of the dielectric material layer 1604L above a top surface of the cladding portion 522 to thereby form the photonic interconnect die 502 of FIG. 16D. As shown in FIG. 16D, remaining portions of the dielectric material layer 1604L may fill the angled trenches (1602a, 1602b) such that a first dielectric window 1604a and a second dielectric window 1604b may be formed.

As shown in FIG. 16D, the photonic interconnect die 502, may include a substrate 520, a dielectric waveguide 104, including a core portion 524 and a cladding portion 522, formed on the substrate 520. The photonic interconnect die 502 may further include a first photonic coupler 112aformed at a first end of the dielectric waveguide 104 and a second photonic coupler 112b formed at a second end of the dielectric waveguide 104. As shown in FIG. 16D, the dielectric waveguide 104 may have a planar geometry within the cladding portion 522 such that a surface 1606 of the dielectric waveguide 104 (e.g., a surface 1606 of the core portion 524) is parallel to a first surface 1608a, of the photonic interconnect die 502. Further, as shown in FIG. 16D, the first photonic coupler 112a and the second photonic coupler 112b each couple photonic signals 310 into and out of the photonic interconnect die such that a photonic signal pathway (see dot-dashed lines) connects the first photonic coupler 112a, the dielectric waveguide 104, and the second photonic coupler 112b.

Further, as shown in FIG. 16D, a first dielectric window 1604a may be located at a first position (e.g., left side) on the first surface 1608a of the photonic interconnect die 502, and a second dielectric window 1604b may be located at a second position (e.g., right side) on the first surface 1608a of the photonic interconnect die 502. In this regard, the first photonic coupler 112aand the second photonic coupler 112b each the couple photonic signals 310 into and out of the photonic interconnect die 502 through the first dielectric window 1604a and the second dielectric window 1604b, respectively.

As shown in FIG. 16D, the first photonic coupler 112a may be configured as a first angled reflector 306c (e.g., see FIG. 5B) that couples photonic signals 310 into the dielectric waveguide 104 that are received from the first dielectric window 1604a. The first photonic coupler 112a may further transmit photonic signals through the first dielectric window 1604a that are received from the dielectric waveguide 104. Similarly, the second photonic coupler 112b may be configured as a second angled reflector 306c (e.g., see FIG. 5B) that couples photonic signals 310 into the dielectric waveguide 104 that are received from the second dielectric window 1604b and transmits photonic signals through the second dielectric window 1604b that are received from the dielectric waveguide 104.

FIGS. 16E - 16H are vertical cross-sectional views of additional photonic interconnect dies 502 including angled reflectors, according to various embodiments. As shown in FIG. 16E, each angled reflector may further include a reflective coating 1610. The reflective coating may be chosen to be a metallic material that may be deposited over each of the angled trenches (1602a, 1602b) of the intermediate structure 1600b of FIG. 16B prior to deposition of the dielectric material layer 1604L. Alternatively, as shown in FIG. 16F, a multi-layer dielectric stack 1612 may be formed over each over each of the angled trenches (1602a, 1602b) of the intermediate structure 1600b of FIG. 16B prior to deposition of the dielectric material layer 1604L.

The multi-layer dielectric stack 1612 may include thin alternating layers of dielectric materials such that the multi-layer dielectric stack 1612 may form a reflector. In this regard, electromagnetic fields that are multiply reflected from the layers of the multi-layer dielectric stack 1612 may constructively interfere such that the multi-layer dielectric stack 1612 acts as a reflector. In some embodiments, the multi-layer dielectric stack 1612 may provide a strongly reflected photonic signal without ohmic loss that may otherwise occur using a metallic reflector 1610.

As shown in FIGS. 16G and 16H, each of the photonic interconnect dies 502 may include a first photonic coupler 112a and a second photonic coupler 112b having a curved reflector surface 806. As described above with reference to FIG. 8C, a curved reflector surface 806 may be generated by performing an etching process using multi-tone masks. As shown in FIG. 16H, the photonic interconnect die may further include a transition edge coupler 1616 structure. As shown, the transition edge coupler 1616 may include additional core portions (524a, 524b) formed adjacent to the core portion 524. The additional core portions (524a, 524b) may be formed using processing operations similar to those described above with reference to FIGS. 14A - 15C. The transition edge coupler 1616 may act to expand a lateral width of an electromagnetic field associated with a photonic signal propagating within the core portion 524 of the dielectric waveguide 104. Similar edge couplers 306b (see FIG. 3D) are described with reference to FIGS. 17A and 17B, below.

FIG. 17A is a top view of a photonic interconnect die 502 including edge couplers 306b (also see FIG. 3D), and FIG. 17B is a vertical cross-sectional view of the photonic interconnect die 502 of FIG. 17A, according to various embodiments. The vertical plane defining the cross-sectional view of FIG. 17B is indicated by the cross-section B – B’ in FIG. 17A. As shown, the photonic interconnect die 502 may include a plurality of dielectric waveguides 104 that include a core portion 524 surrounded by a cladding portion 522. As shown, each core portion 524 may have tapered ends 1702. Each of the tapered ends 1702 of the core portions 524 may be enclosed withing a further region of a dielectric material 1704 to thereby form a spot size converter (SSC). As shown, a distribution of electromagnetic field lines 1706 may be expanded by the edge couplers 306b. In this regard, fields within the core portions may have a smaller lateral distribution than field lines that may be coupled into an out of the photonic interconnect die. As such, the photonic interconnect die 502, including edge couplers 306b, may efficiently coupler photonic signals from a dielectric waveguide 104 to an external optical fiber (not shown).

As shown in FIG. 17B, a first dielectric window 1604a and a second dielectric window 1604b may be formed at respective surfaces (1608b, 1608c) of the first photonic coupler 112a and the second photonic coupler 112b. In this regard, the first dielectric window 1604a may be located on a second surface 1608b of the photonic interconnect die 502 that is perpendicular to the first surface 1608a of the photonic interconnect die 502. Similarly, the second dielectric window 1604b may be located on a third surface 1608c of the photonic interconnect die 502 that is also perpendicular to the first surface 1608a of the photonic interconnect die 502. In this example embodiment, the third surface 1608c of the photonic interconnect die 502 is parallel and opposite to the second surface 1608b. As such, the first photonic coupler 112a and the second photonic coupler 112b each couple photonic signals 310 into and out of the photonic interconnect die 502 through the first dielectric window 1604a and the second dielectric window 1604b, respectively.

FIG. 18A is a top view of an intermediate structure that may be used to form a photonic interconnect die 502 include grating couplers 306a (also see FIG. 3C), FIG. 18B is a vertical cross-sectional view of the intermediate structure of FIG. 18A, according to various embodiments, and FIG. 18C is a vertical cross-sectional view of a photonic interconnect die including grating couplers, according to various embodiments. The vertical plane defining the cross-sectional view of FIG. 18B is indicated by the cross-section B – B’ in FIG. 18A. As shown, each of a plurality of dielectric waveguides 104 may include a respective core portion 524 surrounded by a cladding portion. The dielectric waveguides of FIGS. 18A -18C may be formed by processed similar to those described above with reference to FIGS. 14A - 15C.

As shown in FIG. 18A, each core portion 524 may include grating couplers 306a formed at respective ends of the core portions 524. In this regard, each end of a core portion 524 may include a flared portion that includes a plurality of grooves 308. The grooves may be formed by performing an etching operation in top surfaces of the core portions 524, as shown in FIG. 18B. The photonic interconnect die 502 of FIG. 18C may be formed from the intermediate structure 1800 of FIGS. 18A and 18B buy forming an additional cladding material layer such that the cladding portion 522 surrounds the core portion 524. As shown in FIG. 18C, dielectric windows (1604a, 1604b) may then be formed by depositing a further dielectric material 1604L (see FIG. 16C) over the intermediate structure 1800. Excess portions of the dielectric material layer 1604L may then be removed by performing a planarization process to thereby generate the dielectric windows (1604a, 1604b), as described with reference to FIGS. 16C and 16D, above.

As shown, photonic signals 310 may be coupled into and out from the photonic interconnect die 502 by the photonic couplers (112a, 112b). Thus, as with the embodiments of FIGS. 16D - 16H, the first dielectric window 1604a may be located at a first position (e.g., the left side) on the first surface 1608a of the photonic interconnect die 502 and the second dielectric window 1604b may be located at a second position (e.g., on the right side) on the first surface 1608a of the photonic interconnect die 502.

FIGS. 19A - 19D are vertical cross-sectional views of intermediate structures (1900a to 1900d) that may be used to form a photonic interconnect die, according to various embodiments. The intermediate structure 1900a may be formed by forming a cladding material 522L layer over a substrate (not shown). The cladding material layer 522L may be chosen to be a photosensitive polymer material. A laser-writing operation may then be performed on the cladding material layer 522L to thereby generate a core portion 524. In this regard, as shown in FIG. 19B, a laser 1902 may generate a beam of laser radiation 1904 that may be directed to the cladding material layer 522L at a certain depth 1906 within the cladding material layer. The laser radiation 1904 may be chosen to have a certain beam width 1908.

The interaction of the laser radiation 1904 with the cladding material layer 522L may act to alter the micro-structure of the polymer material of the cladding material layer 522L in a localized region in response to absorption of laser radiation during the laser-writing operation. The altered microstructure may be characterized by an increased refractive index relative to the cladding material layer 522L. As such, the irradiated localized region may then serve as the core portion 524 while a surrounding un-irradiated portion of the cladding material layer 522L may serve as the cladding portion 522, as shown in FIG. 19C. The use of a laser-writing operation may allow considerable flexibility regarding a spatial layout of core portions 524. For example, as shown in FIG. 19D, a plurality of dielectric waveguides 104 may be generated having a non-uniform spatial distribution. For example, the plurality of dielectric waveguides 104 may include a fan-out configuration in which a linear spacing of core portions 524 may laterally increase (e.g., in the y-direction) as a function of a longitudinal direction (e.g., the x-direction).

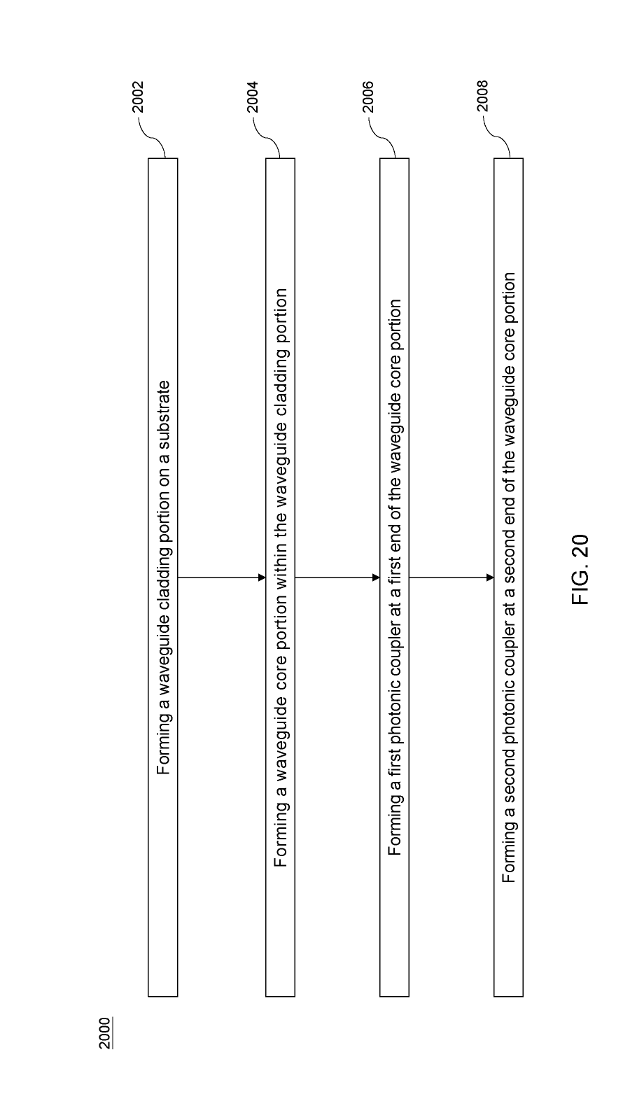

FIG. 20 is a flowchart illustration operations of a method 2000 of forming a photonic interconnect die 502, according to various embodiments. In operation 2002, the method 2000 may include forming a waveguide cladding portion 522 on a substrate 520. In operation 2004, the method 2000 may include forming a waveguide core portion 524 within the waveguide cladding portion 522. In operation 2006, the method 2000 may include forming a first photonic coupler 112a at a first end of the waveguide core portion 524. In operation 2008, the method 2008 may include forming a second photonic coupler 112b at a second end of the waveguide core portion 524.

In forming the cladding portion (522, 304) in operation 2002, and forming the waveguide core portion (524, 302b) in operation 2004, the method 2000 may further include forming a silicon-on-insulator substrate 302 including a silicon substrate 302a, a first silicon dioxide layer 304 formed over the silicon substrate 302a, and a silicon layer 302b formed over the first silicon dioxide layer 304. The method 2000 may further include patterning and etching the silicon layer 302b to form a silicon waveguide core portion (524, 302b). The method 2000 may further include forming a second silicon dioxide layer 304 over the waveguide core portion (522, 304) such that the waveguide core portion 524 is surrounded by silicon dioxide 304 so that the waveguide cladding portion 522 may include the first silicon dioxide layer 304 and the second silicon dioxide layer 304.

In forming the cladding portion (522, 304) in operation 2002, and forming the waveguide core portion (524, 302b) in operation 2004, the method 2000 may further include forming a first layer of a first polymer material 522 over the substrate 520; forming a second layer of a second polymer material 524L over the substrate 520; patterning the second layer of the second polymer material 524L to form the waveguide core portion 524; and forming a third layer of the first polymer material 522 over the waveguide core portion 524, such that the first layer and the third layer of the first polymer material 522 form the waveguide cladding portion 522. In forming the cladding portion (522, 304) in operation 2002, and forming the waveguide core portion (524, 302b) in operation 2004, the method 2000 may further include forming a radiation-curable polymer material 522L over the substrate 520; and irradiating a region of the radiation-curable polymer material 522L with laser radiation 1904 in a laser-writing operation to thereby form the waveguide core portion 524 of a waveguide, such that an un-radiated portion of the radiation-curable polymer material 522L may serve as the waveguide cladding portion 522.

Referring to all drawings and according to various embodiments of the present disclosure, a photonic interconnect die 502 is provided. The photonic interconnect die 502 may include a substrate 520, a dielectric waveguide 104, including a core portion 524 and a cladding portion 522, formed on the substrate 520, a first photonic coupler 112a formed at a first end of the dielectric waveguide 104, and a second photonic coupler 112b formed at a second end of the dielectric waveguide 104. The dielectric waveguide 104 may include a planar geometry within the cladding portion 522 such that a surface of the dielectric waveguide 104 is parallel to a first surface 1608a of the photonic interconnect die 502.

The first photonic coupler 112a and the second photonic coupler 112b may each couple photonic signals 310 into and out of the photonic interconnect die 502 such that a photonic signal pathway (514a, 524, 514b) connects the first photonic coupler 112a, the dielectric waveguide 104, and the second photonic coupler 112b. The photonic interconnect die 502 may further include a first dielectric window 1604a located at a first position on the first surface 1608a of the photonic interconnect die 502 and a second dielectric window 1604b located at a second position on the first surface 1608a of the photonic interconnect die 502. The first photonic coupler 112aand the second photonic coupler 112b may couple photonic signals 310 into and out of the photonic interconnect die 502 through the first dielectric window 1604a and the second dielectric window 1604b, respectively.

In some embodiments, the first photonic coupler 112a may include a first grating coupler 306athat couples first input photonic signals 310 into the dielectric waveguide 104 that are received from the first dielectric window 1604a and transmits first output photonic signals 310 through the first dielectric window 1604a that are received from the dielectric waveguide 104. Similarly, the second photonic coupler 112b may include a second grating coupler 306a that couples second input photonic signals 310 into the dielectric waveguide 104 that are received from the second dielectric window 1604b and transmits second output photonic signals 310 through the second dielectric window 1604b that are received from the dielectric waveguide 104.

In further embodiments, the first photonic coupler 112a may include a first angled reflector 306c that couples first input photonic signals 310 into the dielectric waveguide 104 that are received from the first dielectric window 1604a and transmits first output photonic signals 310 through the first dielectric window 1604a that are received from the dielectric waveguide 104. Similarly, the second photonic coupler 112b may include a second angled reflector 306c that couples second input photonic signals 310 into the dielectric waveguide 104 that are received from the second dielectric window 1604b and transmits second output photonic signals 310 through the second dielectric window 1604b that are received from the dielectric waveguide 104.

In other embodiments, the first dielectric window 1604a may be located on a second surface 1608bof the photonic interconnect die 502 that is perpendicular to the first surface 1608a of the photonic interconnect die 502 and the second dielectric window 1604b may be located on a third surface 1608c of the photonic interconnect die 502 that is perpendicular to the first surface 1608a of the photonic interconnect die 502 such that the third surface 1608c of the photonic interconnect die 502 is parallel and opposite to the second surface 1608b. In such embodiments, the first photonic coupler 112a and the second photonic coupler 112b may each couple the photonic signals 310 into and out of the photonic interconnect die 502 through the first dielectric window 1604a and the second dielectric window 1604b, respectively.

According to certain embodiments, the first photonic coupler 112a may include a first edge coupler 306bthat couples first input photonic signals 310 into the dielectric waveguide 104 that are received from the first dielectric window 1604a and transmits first output photonic signals 310 through the first dielectric window 1604a that are received from the dielectric waveguide 104. Similarly, the second photonic coupler 112bmay include a second edge coupler 306bthat couples second input photonic signals 310 into the dielectric waveguide 104 that are received from the second dielectric window 1604b and transmits second output photonic signals 310 through the second dielectric window 1604b that are received from the dielectric waveguide 104. In some embodiments, each of the first edge coupler 306b and the second edge coupler 306b may include a tapered end 1702 of the dielectric waveguide 104 in contact with an enclosing dielectric material 1704.

According to certain embodiments, each of the first edge coupler 306b and the second edge coupler 306b may include a transition edge coupler 1616. The core portion 524 may include a first material having a first index of refraction and the cladding portion 522 may include a second material having a second index of refraction that is less than the first index of refraction. In some embodiments, the core portion 524 may include silicon and the cladding portion 522 may include silicon dioxide. In other embodiments, the core portion 524 may include a first polymer material and the cladding portion 522 may include a second polymer material.

Referring to all drawings and according to various embodiments of the present disclosure, an electronic/photonic package (400, 500, 700, 800, 900, 1000, 1100, 1200, 1300) is provided. The electronic/photonic package (400, 500, 700, 800, 900, 1000, 1100, 1200, 1300) may include a first photonic component (200a, 402a) including first photonic signal pathways (310, 514a), a second photonic component (200b, 402b) including second photonic signal pathways (310b, 514b), and a photonic interconnect die 502 including a plurality of dielectric waveguides 104. The photonic interconnect die 502 may be coupled to the first photonic component (200a, 402a) and the second photonic component (200b, 402b) such that the first photonic signal pathways (310, 514a) are photonically coupled to the second photonic signal pathways (310b, 514b) by the plurality of dielectric waveguides 104.

The electronic/photonic package (400, 500, 700, 800, 900, 1000, 1100, 1200, 1300) may further include an interposer 408, such that the first photonic component (200a, 402a) and the second photonic component (200b, 402b) are formed as separate dies and are attached to, and electrically coupled to, the interposer 408. A first portion 526aof the photonic interconnect die 502 may be mechanically and photonically coupled to the first photonic component (200a, 402a) and a second portion 526b of the photonic interconnect die 502 may be mechanically and photonically coupled to the second photonic component (200b, 402b) so that the photonic interconnect die 502 is configured as an intra-package photonic coupler (502a, 502c, see FIG. 8B).

In further embodiments, the electronic/photonic package (400, 500, 700, 800, 900, 1000, 1100, 1200, 1300) may include a first interposer 408a, and a second interposer 408b, such that the first photonic component (200a, 402a) is attached to, and electrically coupled to, the first interposer 408a, and the second photonic component (200b, 402b) is attached to, and electrically coupled to, the second interposer 408b. In this regard, a first portion 526a of the photonic interconnect die 502 may be mechanically and photonically coupled to the first photonic component (200a, 402a) and a second portion 526b of the photonic interconnect die 502 may be mechanically and photonically coupled to the second photonic component (200b, 402b) so that the photonic interconnect die 502 is configured as an inter-package photonic coupler 502b (see FIG. 8B).

According to various embodiments, a photonic interconnect die 502 may further include a substrate 520, a cladding portion 522 formed on the substrate 520, a plurality of dielectric waveguide core portions 524 formed within the cladding portion a plurality of first photonic couplers 112a, and a plurality of second photonic couplers 112b. According to various embodiments, respective ones of the plurality of first photonic couplers 112a and the plurality of second photonic couplers 112b are coupled to first and second ends of respective ones of the plurality of dielectric waveguide core portions 524. Further, the plurality of first photonic couplers 112a and the plurality of second photonic couplers 112b may be configured to guide photonic signals 310 into and out of the photonic interconnect die 502 such that a respective photonic signal pathway (310c, 524) connects each of the plurality of dielectric waveguides 104 with respective ones of the plurality of first photonic couplers 112a and the plurality of second photonic couplers 112b. In some embodiments, the plurality of dielectric waveguides 104 may be formed on a common planar substrate 520 and may include a fan-out configuration (see FIG. 19D). Alternatively, the plurality of dielectric waveguides 104 may be arranged in a three-dimensional configuration (see FIG. 15C) within the cladding portion 522.

Disclosed embodiments provide photonic interconnect dies 502 that allow photonic signals 310 to be propagated between a first photonic component (200a, 402a) and a second photonic component (200b, 402b) in an electronic/photonic package (400, 500, 700, 800, 900, 1000, 1100, 1200, 1300). The incorporation of optical/photonic signaling functionality into an electronic/photonic package (400, 500, 700, 800, 900, 1000, 1100, 1200, 1300) may provide reduced signal delay and ohmic loss. In this regard, in certain embodiments, to avoid long electrical signal pathways and associated delay and ohmic loss, it may be advantageous to convey signals in the form of photonic signals 310 along a portion of the signal pathway.

This may be done by converting electrical signals into photonic signals 310 at a first point along the signal pathway, propagating the photonic signals for a certain distance, and then converting the photonic signals back into electrical signals at a second point along the signal pathway. In still further embodiments, the functionality to convert electrical signals into photonic signals 310 and vice versa may be advantageous in photonic (quantum or classical) computing operations. The use of photonic interconnect dies 502 allows various electronic and photonic components (200, 402) to be fabricated separately as stand-alone dies. Such dies may then be assembled into an electronic/photonic package (400, 500, 700, 800, 900, 1000, 1100, 1200, 1300) and photonic components may be coupled by photonic interconnect dies 502.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure

What is claimed is:

1. A photonic interconnect die, comprising:
a substrate;
a dielectric waveguide, comprising a core portion and a cladding portion, formed on the substrate;
a first photonic coupler formed at a first end of the dielectric waveguide; and
a second photonic coupler formed at a second end of the dielectric waveguide,
wherein the dielectric waveguide comprises a planar geometry within the cladding portion such that a surface of the dielectric waveguide is parallel to a first surface of the photonic interconnect die, and
wherein the first photonic coupler and the second photonic coupler each couple photonic signals into and out of the photonic interconnect die such that a photonic signal pathway connects the first photonic coupler, the dielectric waveguide, and the second photonic coupler.

2. The photonic interconnect die of claim 1, further comprising:
a first dielectric window located at a first position on the first surface of the photonic interconnect die; and
a second dielectric window located at a second position on the first surface of the photonic interconnect die,
wherein the first photonic coupler and the second photonic coupler each couple photonic signals into and out of the photonic interconnect die through the first dielectric window and the second dielectric window, respectively.

3. The photonic interconnect die of claim 2, wherein:
the first photonic coupler comprises a first grating coupler that couples first input photonic signals into the dielectric waveguide that are received from the first dielectric window and transmits first output photonic signals through the first dielectric window that are received from the dielectric waveguide; and
the second photonic coupler comprises a second grating coupler that couples second input photonic signals into the dielectric waveguide that are received from the second dielectric window and transmits second output photonic signals through the second dielectric window that are received from the dielectric waveguide.

4. The photonic interconnect die of claim 2, wherein:
the first photonic coupler comprises a first angled reflector that couples first input photonic signals into the dielectric waveguide that are received from the first dielectric window and transmits first output photonic signals through the first dielectric window that are received from the dielectric waveguide; and
the second photonic coupler comprises a second angled reflector that couples second input photonic signals into the dielectric waveguide that are received from the second dielectric window and transmits second output photonic signals through the second dielectric window that are received from the dielectric waveguide.

5. The photonic interconnect die of claim 1, further comprising:
a first dielectric window located on a second surface of the photonic interconnect die that is perpendicular to the first surface of the photonic interconnect die; and
a second dielectric window located on a third surface of the photonic interconnect die that is perpendicular to the first surface of the photonic interconnect die such that the third surface of the photonic interconnect die is parallel and opposite to the second surface,
wherein the first photonic coupler and the second photonic coupler each couple the photonic signals into and out of the photonic interconnect die through the first dielectric window and the second dielectric window, respectively.

6. The photonic interconnect die of claim 5, wherein:
the first photonic coupler comprises a first edge coupler that couples first input photonic signals into the dielectric waveguide that are received from the first dielectric window and transmits first output photonic signals through the first dielectric window that are received from the dielectric waveguide; and
the second photonic coupler comprises a second edge coupler that couples second input photonic signals into the dielectric waveguide that are received from the second dielectric window and transmits second output photonic signals through the second dielectric window that are received from the dielectric waveguide.

7. The photonic interconnect die of claim 6, wherein each of the first edge coupler and the second edge coupler comprises a tapered end of the dielectric waveguide in contact with an enclosing dielectric material.

8. The photonic interconnect die of claim 6, wherein each of the first edge coupler and the second edge coupler comprises a transition edge coupler.

9. The photonic interconnect die of claim 1, wherein the core portion comprises a first material having a first index of refraction and the cladding portion comprises a second material having a second index of refraction that is less than the first index of refraction.

10. The photonic interconnect die of claim 1, wherein the core portion comprises silicon and the cladding portion comprises silicon dioxide.

11. The photonic interconnect die of claim 1, wherein the core portion comprises a first polymer material and the cladding portion comprises a second polymer material.

12. An electronic/photonic package, comprising:
a first photonic component comprising first photonic signal pathways;
a second photonic component comprising second photonic signal pathways; and
a photonic interconnect die comprising a plurality of dielectric waveguides,
wherein the photonic interconnect die is coupled to the first photonic component and the second photonic component such that the first photonic signal pathways are photonically coupled to the second photonic signal pathways by the plurality of dielectric waveguides.

13. The electronic/photonic package of claim 12, further comprising:
an interposer,
wherein the first photonic component and the second photonic component are formed as separate dies and are attached to, and electrically coupled to, the interposer, and
wherein a first portion of the photonic interconnect die is mechanically and photonically coupled to the first photonic component and a second portion of the photonic interconnect die is mechanically and photonically coupled to the second photonic component so that the photonic interconnect die is configured as an intra-package photonic coupler.

14. The electronic/photonic package of claim 12, further comprising:
a first interposer; and
a second interposer,
wherein:
the first photonic component is attached to, and electrically coupled to, the first interposer; and
the second photonic component is attached to, and electrically coupled to, the second interposer, and
wherein a first portion of the photonic interconnect die is mechanically and photonically coupled to the first photonic component and a second portion of the photonic interconnect die is mechanically and photonically coupled to the second photonic component so that the photonic interconnect die is configured as an inter-package photonic coupler.

15. The electronic/photonic package of claim 12, wherein the photonic interconnect die further comprises:
a substrate;
a cladding portion formed on the substrate;
a plurality of dielectric waveguide core portions formed within the cladding portion;
a plurality of first photonic couplers; and
a plurality of second photonic couplers,
wherein respective ones of the plurality of first photonic couplers and the plurality of second photonic couplers are coupled to first and second ends of respective ones of the plurality of dielectric waveguide core portions, and
wherein the plurality of first photonic couplers and the plurality of second photonic couplers guide photonic signals into and out of the photonic interconnect die such that a respective photonic signal pathway connects each of the plurality of dielectric waveguides with respective ones of the plurality of first photonic couplers and the plurality of second photonic couplers.

16. The electronic/photonic package of claim 15, wherein:
the plurality of dielectric waveguides are formed on a common planar substrate and comprise a fan-out configuration, or
the plurality of dielectric waveguides is arranged in a three-dimensional configuration within the cladding portion.

17. A fiber array unit, comprising:
a housing comprising a curved reflector surface and a fiber coupler section;
a plurality of grooves formed in the housing within the fiber coupler section, wherein each groove is configured to receive an optical fiber; and
a coupling surface of the housing positioned between the plurality of grooves and the curved reflector surface,
wherein the curved reflector surface is configured to reflect photonic signals between the fiber coupler section and a photonic component.

18. The fiber array unit of claim 17, wherein a groove of the plurality of grooves comprises internal surfaces that are angled relative to a plane parallel to a surface of the housing such that an optical fiber having a fixed diameter is seated within the groove to a depth relative to the surface of the housing, wherein the depth is a geometric function of an angle of the internal surfaces.

19. The fiber array unit of claim 17, wherein the curved reflector surface comprises a variable curvature including a first portion having a first radius of curvature and a second portion having a second radius of curvature different from the first radius of curvature.

20. The fiber array unit of claim 17, further comprising an optical adhesive formed between ends of optical fibers positioned within the plurality of grooves and the coupling surface of the housing.
